(19) United States
(12) Patent Application Publication
(10) Pub. No.: US 2023/0340172 A1
(43) Pub. Date: Oct. 26, 2023

(54) VINYL ALCOHOL POLYMER AND USE THEREOF

(71) Applicant: KURARAY CO., LTD., Okayama (JP)

(72) Inventors: Masaki Kato, Houston, TX (US); Yuta Taoka, Houston, TX (US); Yoriko Imaoka, Okayama (JP); Ayumu Yamamoto, Okayama (JP); Yasuhiro Tajima, Okayama (JP)

(73) Assignee: KURARAY CO., LTD., Okayama (JP)

(21) Appl. No.: 18/041,253

(22) PCT Filed: Aug. 11, 2021
(86) PCT No.: PCT/JP2021/029678

§ 371 Date: Feb. 10, 2023

(30) Foreign Application Priority Data
Aug. 12, 2020 (JP) 2020-136515
Aug. 12, 2020 (JP) 2020-136516
Aug. 12, 2020 (JP) 2020-136517
Aug. 12, 2020 (JP) 2020-136518
Aug. 12, 2020 (JP) 2020-136519
Aug. 12, 2020 (JP) 2020-136520
Aug. 12, 2020 (JP) 2020-136521
Aug. 12, 2020 (JP) 2020-136522
May 12, 2021 (JP) 2021-081302

(51) Int. Cl. C08F 216/06; C08L 23/08; C08F 2/20; C09K 8/24; C09K 8/035; C09D 129/04; C04B 24/26

(52) U.S. Cl. CPC C08F 216/06; C08L 23/0861; C08F 2/20; C09K 8/24; C09K 8/035; C09D 129/04; C04B 24/2623; C08L 2201/14

(57) ABSTRACT

The present invention provides a vinyl alcohol polymer having properties comparable to the properties of vinyl alcohol polymers of solely petroleum origin, and, in using the vinyl alcohol polymer (PVA), saves petroleum resources, and reduces carbon dioxide emissions in production processes. The present invention relates to a vinyl alcohol polymer (X) obtained through saponification after polymerization of a plant-derived vinyl ester monomer (A) and a petroleum-derived vinyl ester monomer (B), and having a mole ratio (A)/(B) of 5/95 to 100/0.

### TECHNICAL FIELD

The present invention relates to a vinyl alcohol polymer obtained through saponification after polymerization of vinyl acetate synthesized from a plant-derived raw material such as biomass, and to additives for slurries, drilling muds, cement slurries, and sealing agents for underground treatment using same. The invention also relates to a multilayer structure using the vinyl alcohol polymer and having excellent oxygen gas barrier properties, a method of production thereof, and packaging materials including such a multilayer structure, and to papercoating agents, coated papers, seed coating compositions, aqueous emulsions, adhesive agents, dispersion stabilizers for suspension polymerization of vinyl compounds, and auxiliary dispersion stabilizers for suspension polymerization of vinyl compounds using the vinyl alcohol polymer.

### BACKGROUND ART

A vinyl alcohol polymer (hereinafter, vinyl alcohol polymer is also referred to with the abbreviation “PVA”) obtained through saponification after polymerization of vinyl acetate exhibits excellent interface characteristics and strength characteristics as one of the few crystalline water-soluble polymers. Because of these properties, PVA has been used in paper processing and fiberworking, and as an emulsion stabilizer. PVA also has an important place in applications such as PVA films and PVA fibers.

The raw material ethylene and acetic acid of vinyl acetate are produced from fossil resources—petroleum or natural gas. Specifically, ethylene is produced by mixing hydrocarbons, primarily naphtha, with steam, and separating the product by distillation after pyrolysis. Acetic acid is produced through carbonylation of methanol obtained by a reaction of hydrogen with carbon monoxide produced by partial oxidation of natural gas.

These fossil resources are at risk of being depleted, and there are concerns that carbon dioxide emissions from production processes will accelerate global warming.

Conventionally, a slurry for civil engineering and construction, such as a drilling cement, is used in wells for extraction of deposits such as petroleum and natural gas.

A drilling mud has many roles, such as in, for example, carrying drill cuttings such as rock fragments and drill dust, improving the lubricity of bits or drill pipes, burying pores in porous ground, and balancing the reservoir pressure (the pressure of rock) created by hydrostatic pressure. Typically, the intended capabilities of drilling mud are achieved by using water and bentonite as main components, and adding additives such as barite, salt, and clay. Such drilling muds are required to have adequate flow properties, such as having temperature stability, and not being greatly affected by changes in the concentration of electrolytes (for example, carboxylates) in the ground. In order to meet these requirements, it is required to adjust the viscosity of drilling mud, and to reduce dissipation of water (or dehydration as it is also called) contained in the drilling mud. The viscosity adjustment and reduction of dehydration in drilling muds are usually achieved by a method that adds a polymer, for example, such as starch, starch ether (e.g., carboxymethyl starch), carboxymethyl cellulose, or carboxymethyl hydroxyethyl cellulose.

However, addition of these polymers may excessively increase the viscosity of drilling mud, and make it difficult to inject drilling mud with a pump. Another issue is that sufficient reduction of dehydration cannot be achieved with starch and its derivatives in a temperature region higher than about 120° C. Carboxymethyl cellulose and carboxymethyl hydroxyethyl cellulose cannot sufficiently reduce dehydration in a temperature region of 140° C. to 150° C.

A drilling cement slurry is used by, for example, being injected and hardened in the annular space between the stratum and a casing pipe installed in the wellbore, in order to secure the casing pipe in the well, or to protect the inner wall in the well. Normally, a pump is used to inject a drilling cement slurry into the annular space. Accordingly, a drilling cement slurry needs to have an extremely low viscosity to enable easy injection, in addition to undergoing no segregation.

However, defects may occur in cemented portions in cementing a wellbore as a result of, for example, material segregation, or dissipation of water into the fractures in the well. It is accordingly common practice to add a dehydration reducing agent, such as walnut shells, cottonseeds, clay minerals, or high-molecular compounds, to the drilling cement slurry. A vinyl alcohol polymer is a well-known dehydration reducing agent.

In relation to a vinyl alcohol polymer as a dehydration reducing agent, for example, Patent Literature 1 discloses a method that uses a PVA having a degree of saponification of 95 mol % or more.

Patent Literature 2 discloses a method that uses a PVA having a degree of saponification of 92 mol % or less.

Patent Literature 3 discloses a method that uses a PVA having a degree of saponification of 99 mol % or more.

Low recovery rates of petroleum and other underground resources remain an issue in recovering such resources from the natural resource layer below ground. Various techniques are used to mitigate this issue. One common technique is a method that injects a fluid into the underground oil pool for displacement. A variety of fluids are used, including salt water, clear water, aqueous solutions of polymers, and steam. Aqueous solutions of polymers are particularly useful.

As an example, a method is widely used that injects steam into the underground shale layer to create fractures. In this method, a vertical hole (vertical wellbore), several thousand meters deep, is bored with a drill, and, upon reaching the shale layer, the layer is horizontally drilled to form a horizontal hole (horizontal wellbore) of a diameter that is ten centimeters to several tens of centimeter. This is followed by injection of a polymer aqueous solution into the vertical and horizontal wellbores under pressure to create fractures, and natural gas, petroleum (shale gasoil), and other resources that flow out of the fractures are recovered.

Here, a sealing agent (additive) for underground treatment is often used to temporarily plug parts of existing fractures to further grow existing fractures or create more fractures. Under the pressure applied in this state to the fracturing fluid filling the wellbore, the fluid can penetrate into other fractures to further grow existing fractures or create more fractures.

Because a sealing agent for underground treatment (or a diverting agent as it is also called) is used to temporarily plug fractures in the manner described above, certain types of sealing agents used for this purpose can maintain its shape for a certain time period while plugging fractures, and later undergo hydrolysis and disappear, or dissolve away when recovering resources such as natural gas and petroleum.

For example, there are examples in which PVA is used as a sealing agent for underground treatment. Patent Literature 2 discloses a diverting agent containing PVA.

Patent Literature 3 discloses a diverting agent containing resin particles of PVA having specific particle diameters.

Patent Literature 4 discloses a PVA-containing sealing agent for underground treatment having a specific range of swelling rate after being immersed in 80° C. water for 30 minutes.

Multilayer structures that excel in oxygen gas barrier properties are used in applications such as packaging materials. Aluminum foil has perfect oxygen gas barrier properties, and is used as an intermediate layer of such multilayer structures. A problem, however, is that a multilayer structure including aluminum foil leaves remnants when burned, or does not provide visual access to its contents or allow detection of its contents with a metal detector when used as a packaging material.

Polyvinylidene chloride (hereinafter, also referred to with the abbreviation “PVDC”) does not easily absorb moisture, and exhibits desirable oxygen gas barrier properties even under high humidity. Because of these properties, polyvinylidene chloride is coated on various substrates to form multilayer structures to be used in applications such as packaging materials. Examples of such substrates include films such as biaxially oriented polypropylene (hereinafter, also referred to with the abbreviation “OPP”), biaxially oriented nylon (hereinafter, also referred to with the abbreviation “ON”), biaxially oriented polyethylene terephthalate (hereinafter, also referred to with the abbreviation “OPET”), and cellophane. However, a multilayer structure containing PVDC generates hydrogen chloride gas when its waste is burned.

As an example, Patent Literature 5 describes a PVA-containing film containing 3 to 19 mol % of an a-olefin unit having 4 or less carbon atoms. The film is described as having excellent water resistance, and excellent oxygen gas barrier properties even under high humidity.

It is known that coating of paper with PVA enhances paper strength, and imparts properties such as water resistance, oil resistance, and gas barrier properties. Such coated papers are in wide use. A vinyl alcohol polymer is also used as an inorganic binder or a dispersion stabilizer to serve as an auxiliary agent that imparts functions to paper. As an example of use of PVA as a papercoating agent, for example, Patent Literature 6 discloses an example using PVA as a papercoating agent.

Seed treatment refers to the application of a material to the seed to improve handling characteristics, protect the seed prior to germination, as well as to support the germination process. In addition, seed treatments impart pest resistance properties to the seed or resulting plant by incorporating active “pesticide” ingredients such as insecticides, fungicides, and nematocides. Plant growth regulators which improve the handling characteristics of the seeds may also be added to the seed coating formulation. Seed treatment eliminates, or at least reduces, the need for traditional broad castsprays of foliar fungicides or insecticides.

Many known seed treatments unfortunately are known to produce excessive dust during storage and application of seed material, may result in bulk seed clumping, and may reduce germination efficiency.

For example, Patent Literatures 7 to 20 disclose various and numerous seed coating compositions and ingredients which improve seed handling, germination, and storage and growth properties.

Aqueous seed coating compositions typically comprise an aqueous medium, one or more functional additives, a binder which forms a matrix for the various functional p additives upon drying after application, as well as a protective film for covering the seed.

Some seed treatments incorporate preventative treatments and enhancements, for example, treatments having a pesticide (e.g., a fungicide and/or insecticide) in combination with one or more plant inducers and/or inoculants.

As disclosed in the previously incorporated references, many different materials have been used as binders in aqueous seed coating compositions.

For example, among the binder materials disclosed in Patent Literatures 8 to 15 are generally included polyvinyl alcohol homopolymers, copolymers, and functionally modified and/or crosslinked versions thereof.

Some of the commercially available polymeric binders, including some polyvinyl alcohols, suffer from low water solubility/dipole solubility, low coated seed flowability, high levels of dust-off and/or poor plantability characteristics.

For example, a seed coating additive optimized to reduce dust-off may result in poor seed flowability. This can be explained by the fact that ingredients added to increase the stickiness of a coating, so that it is less susceptible to dusting, can cause unacceptably poor flowability and plantability characteristics since the stickiness which normally reduces dust-off creates flowability problems.

On the other hand, the factors which increase seed flowability characteristics of the coating have negative impact on dust-off properties. For planting seeds mechanically, it is essential that the seeds do not agglomerate. Seeds coated with polymeric binders that have inadequate hydrophobicity will stick together, particularly when exposed to warm, humid air such as is encountered in summer in a storage barn.

There is a need for a water-based, biodegradable, and cost-effective seed coating which improves the long-term storage stability, provides low dust-off properties while maintaining or even improving the seed's germination and seed handling properties.

By taking advantage of the water soluble properties, PVA is widely used as a paper processing agent, a textile processing agent, a binder for inorganic materials, an adhesive agent, or a stabilizer for emulsion polymerization and suspension polymerization, in addition to having use as raw material of fibers and films. Specifically, PVA is known as a dispersion stabilizer for emulsion polymerization of vinyl ester monomers such as vinyl acetate. An vinyl ester aqueous emulsion obtained by emulsion polymerization using PVA as a dispersion stabilizer for emulsion polymerization is used in a wide range of fields, including various adhesive agents for woodworking and other purposes, paint bases, coating agents, various binders for impregnated paper and nonwoven products, chemical admixtures, concrete bonding agents, paper processing, and fiberworking.

For example, Patent Literature 21 discloses an aqueous emulsion having excellent high-speed coating properties and initial adhesiveness.

Patent Literature 22 discloses an adhesive agent for woodworking that exhibits excellent waterproof adhesive properties with the use of a PVA containing 1 to 10 mol % ethylene unit.

PVA is commonly used as a dispersant for suspension polymerization of vinyl chloride. In suspension polymerization, a vinyl compound dispersed in an aqueous medium is polymerized using an oil-soluble catalyst to obtain a particulate vinyl polymer. Here, a dispersant is added to the aqueous medium for the purpose of improving the quality of the resulting polymer. The factors that dictate the quality of the vinyl polymer obtained by suspension polymerization of a vinyl compound include the polymerization conversion rate, the ratio of water and vinyl compound (monomer), the polymerization temperature, the type and amount of oil-soluble catalyst, the format of a polymerization vessel, the stirring speed of the contents in a polymerization vessel, and the type of dispersant. Particularly, the type of dispersant greatly influences the particle size distribution, plasticizer absorbability, or other qualities of the vinyl polymer. PVA is used as a dispersant, either alone or in combination with a cellulose derivative such as methyl cellulose or carboxymethyl cellulose.

For example, there are examples in which PVA is used as a dispersion stabilizer for suspension polymerization. In Non Patent Literature 1, a PVA having a degree of polymerization of 2,000, and a degree of saponification of 80 mol %, and a PVA having a degree of polymerization of 700 to 800, and a degree of saponification of 70 mol % are disclosed as dispersants used for suspension polymerization of vinyl chloride.

Patent Literature 23 discloses a dispersant formed of a PVA in which the average degree of polymerization is 500 or more, the ratio Pw/Pn of weight average degree of polymerization Pw to number average degree of polymerization Pn is 3.0 or less, and that has a structure [—CO—(CH═CH)_{2]} including a carbonyl group and the adjacent vinylene group, an absorbance of 0.3 or more at 280 nm and an absorbance of 0.15 or more at 320 nm wavelength in a 0.1% aqueous solution, and a (b)/(a) of 0.30 or more, where (a) is the absorbance at 280 nm wavelength, and (b) is the absorbance at 320 nm wavelength.

Conventionally, it is known to use a partially saponified vinyl alcohol polymer as a dispersant for suspension polymerization of a vinyl compound (for example, vinyl chloride). It cannot be said, however, that the vinyl resin obtained by using an ordinary partially saponified PVA is necessarily satisfactory in terms of the required performance, specifically, for example, (1) high plasticizer absorbability even when used in small amounts, (2) no foreign materials such as fisheyes, (3) easy removal of residual monomer components, and (4) little formation of coarse particles.

Various methods are proposed that use PVA as a dispersion aid for suspension polymerization of vinyl compounds to satisfy such required performance, including, for example, a method that uses a PVA having a low degree of polymerization and a low degree of saponification, and having an oxyalkylene group on a side chain (see Patent Literatures 24 to 30), a method that uses a PVA having an ionic group (see Patent Literature 31), and a method that uses a PVA having a terminal alkyl group, and feeds the PVA into a polymerization vessel in the form of an aqueous solution prepared in advance (see Patent Literature 32).

Indeed, it has been difficult to provide a vinyl alcohol polymer having the same level or even superior properties to vinyl alcohol polymers of solely petroleum origin, and capable of saving petroleum resources, and reducing carbon dioxide emissions in production processes. Previous studies have attempted to change the composition of a resin composition depending on the application to reduce the amount of petroleum resource used. For example, a packing bag is developed that contains a biodegradable resin composition obtained by adding a biodegradable resin other than petroleum-derived raw materials to a resin composition (see Patent Literature 33). However, such articles are far inferior to those made of petroleum-based resin in terms of processing suitability such as tensile strength, tearing strength, seal strength, and firmness, and it has been difficult to improve productivity and durability (for example, see paragraph 0004 of JP2021-14311 A).

### CITATION LIST

### Patent Literature

Patent Literature 1: JP 2000-119585 A

Patent Literature 2: WO2019/031613

Patent Literature 3: WO2019/131939

Patent Literature 4: WO2019/131952

Patent Literature 5: JP 2000-119585 A

Patent Literature 6: JP 2017-43872 A

Patent Literature 7: U.S. Patent Application Publication No. 3698133

Patent Literature 8: U.S. Patent Application Publication No. 3707807

Patent Literature 9: U.S. Patent Application Publication No. 3947996

Patent Literature 10: U.S. Patent Application Publication No. 4249343

Patent Literature 11: U.S. Patent Application Publication No. 4272417

Patent Literature 12: U.S. Patent Application Publication No. 5849320

Patent Literature 13: U.S. Patent Application Publication No. 5876739

Patent Literature 14: U.S. Pat. No. 90101131

Patent Literature 15: WO2017/187994

Patent Literature 16: U.S. Patent Application Publication No. 4729190

Patent Literature 17: WO90/11011

Patent Literature 18: WO2005/062899

Patent Literature 19: WO2008/037489

Patent Literature 20: WO2013/166020

Patent Literature 21: Japanese Patent Number 6647217

Patent Literature 22: Japanese Patent Number 3466316

Patent Literature 23: JP H5-88251 B

Patent Literature 24: JP H9-100301 A

Patent Literature 25: JP H10-147604 A

Patent Literature 26: JP H10-259213 A

Patent Literature 27: JP H11-217413 A

Patent Literature 28: JP 2001-040019 A

Patent Literature 29: JP 2002-069105 A

Patent Literature 30: JP 2007-063369 A

Patent Literature 31: JP H10-168128 A

Patent Literature 32: WO2015/019614

Patent Literature 33: JP 2009-155516 A

### Non Patent Literature

Non Patent Literature 1: Poval, Kobunshikankokai, published 1984, pp. 369 to 373, and 411

### SUMMARY OF INVENTION

### Technical Problem

A vinyl alcohol polymer is not available that has the same level or even superior properties to vinyl alcohol polymers of solely petroleum origin, and that is capable of saving petroleum resources, and reducing carbon dioxide emissions in production processes.

It is an object of the present invention to provide a vinyl alcohol polymer having the same level or even superior properties to vinyl alcohol polymers of solely petroleum origin. Another object of the present invention is to provide a vinyl alcohol polymer having the same level or even superior properties to vinyl alcohol polymers of solely petroleum origin, and, in using the vinyl alcohol polymer (PVA), save petroleum resources, and reduce carbon dioxide emissions in production processes.

Yet another object of the present invention is to save petroleum resources, and reduce carbon dioxide emissions in production processes in using the vinyl alcohol polymer (PVA) for additives for slurries, drilling muds, cement slurries, sealing agents for underground treatment, a multilayer structure having excellent oxygen gas barrier properties, a method of production thereof, and packaging materials including same, as well as papercoating agents, coated paper, seed coating compositions, aqueous emulsions, adhesive agents, dispersion stabilizers for suspension polymerization of vinyl compounds, and auxiliary dispersion stabilizers for suspension polymerization of vinyl compounds. Still another object of the present invention is to provide a sealing agent for underground treatment comprising a vinyl alcohol polymer (PVA) having no appearance defects.

### Solution to Problem

After intensive studies, the present inventors found that the foregoing objects can be achieved with the use of a vinyl alcohol polymer obtained through saponification after polymerization of vinyl ester monomers, using a plant-derived vinyl ester monomer as part of the vinyl alcohol polymer. This finding led to the present invention.

Specifically, the present invention includes the following.
[1] A vinyl alcohol polymer (X) obtained through saponification after polymerization of a plant-derived vinyl ester monomer (A) and a petroleum-derived vinyl ester monomer (B), and having a mole ratio (A)/(B) of 5/95 to 100/0.
[2] The vinyl alcohol polymer (X) according to [1], which comprises an ethylene unit, the content of the ethylene unit being 1 mol % or more and less than 20 mol %.
[3] An additive for slurries, comprising a vinyl alcohol polymer (X) of [1] or [2].
[4] A drilling mud comprising an additive for slurries of [3].
[5] The drilling mud according to [4], which further comprises water and bentonite.
[6] A cement slurry comprising an additive for slurries of [3].
[7] The cement slurry according to [6], which further comprises a liquid and a hardening powder.
[8] A sealing agent for underground treatment, comprising a vinyl alcohol polymer (X) of [1] or [2], and having a mole ratio (A)/(B) of 5/95 to 90/10.
[9] The sealing agent for underground treatment according to [8], wherein the vinyl alcohol polymer (X) comprises an additional unsaturated monomer (C) that is copolymerizable with vinyl ester monomers.
[10] The sealing agent for underground treatment according to [8] or [9], which further comprises a plasticizer.
[11] A multilayer structure comprising a layer (C) containing a vinyl alcohol polymer (X) of [1] or [2], and a layer (D) containing a resin,
   the resin being at least one selected from the group consisting of a polyolefin resin, a polyester resin, a polyamide resin, a polyvinyl chloride (PVC) resin, an ABS resin, a polylactic acid (PLA) resin, a polybutylene succinate (PBS) resin, a polyhydroxyalkanoate (PHA) resin, a polyhydroxybutyrate/hydroxyhexanoate (PHBH) resin, a starch, and a cellulose.
[12] A method for producing a multilayer structure of [11], comprising the steps of:
   obtaining a coating agent by preparing an aqueous solution containing the vinyl alcohol polymer (X); and
   coating the coating agent on a surface of a substrate containing a resin,
   the resin being at least one selected from the group consisting of a polyolefin resin, a polyester resin, a polyamide resin, a polyvinyl chloride (PVC) resin, an ABS resin, a polylactic acid (PLA) resin, a polybutylene succinate (PBS) resin, a polyhydroxyalkanoate (PHA) resin, a polyhydroxybutyrate/hydroxyhexanoate (PHBH) resin, a starch, and a cellulose.
[13] A packaging material comprising a multilayer structure of [11].
[14] A papercoating agent comprising a vinyl alcohol polymer (X) of [1] or [2].
[15] A coated paper comprising a paper coated with a papercoating agent of [14].
[16] The coated paper according to [15], which is a release paper base.
[17] The coated paper according to [15], which is a greaseproof paper.
[18] A seed coating composition comprising a vinyl alcohol polymer (X) of [1] or [2].
[19] The seed coating composition according to [18], which further comprises one or more hydrophobic pesticides.
[20] An aqueous emulsion comprising a dispersant and a dispersoid,
   the dispersoid comprising a polymer (Y1) containing an ethylenically unsaturated monomer unit,
   the dispersant comprising a vinyl alcohol polymer (X) of [1] or [2].
[21] The aqueous emulsion according to [20], wherein:
   the polymer (Y1) containing an ethylenically unsaturated monomer unit is a polymer having a specific unit derived from at least one selected from the group consisting of a vinyl ester monomer, a (meth)acrylic acid ester monomer, a styrene monomer, and a diene monomer, and
   the content of the unit is 70 mass % or more with respect to all monomer units of the polymer.
[22] The aqueous emulsion according to [20] or [21], which further comprises a polyisocyanate compound.
[23] An adhesive agent comprising an aqueous emulsion of any one of [20] to [22].
[24] A dispersion stabilizer for suspension polymerization of vinyl compounds, comprising a vinyl alcohol polymer (X) of [1] or [2].
[25] A method for producing a vinyl resin, comprising the step of polymerizing a vinyl compound by suspension polymerization in the presence of a dispersion stabilizer for suspension polymerization of [24].
[26] The method for producing a vinyl resin according to [25], which comprises the step of polymerizing a vinyl compound by suspension polymerization in the presence of the dispersion stabilizer for suspension polymerization and an auxiliary dispersion stabilizer,
   the auxiliary dispersion stabilizer comprising a vinyl alcohol polymer (Y2) having a degree of saponification of less than 65 mol %.
[27] An auxiliary dispersion stabilizer for suspension polymerization of vinyl compounds, comprising a vinyl alcohol polymer (X) of [1] or [2],
   the vinyl alcohol polymer (X) having a degree of saponification of 20 mol % or more and less than 60 mol %.
[28] A method for producing a vinyl resin, comprising the step of polymerizing a vinyl compound by suspension polymerization in the presence of an auxiliary dispersion stabilizer for suspension polymerization of [27] and a dispersion stabilizer for suspension polymerization,
   the dispersion stabilizer for suspension polymerization comprising a vinyl alcohol polymer (Y3) having a degree of saponification of 65 mol % or more, and a viscosity-average degree of polymerization of 600 or more.
[29] The method for producing a vinyl resin according to [28], wherein the dispersion stabilizer and the auxiliary dispersion stabilizer have a mass ratio of 95/5 to 20/80 (dispersion stabilizer/auxiliary dispersion stabilizer).

### Advantageous Effects of Invention

According to the present invention, a vinyl alcohol polymer can be provided that, by being partly plant-derived, has the same level or even superior properties to vinyl alcohol polymers derived solely from petroleum. This enables the present invention to save petroleum resources, and reduce carbon dioxide emissions in production processes, and, in turn, global warming.

According to the present invention, a partly plant-derived PVA is used for additives for slurries, drilling muds, cement slurries, sealing agents for underground treatment, a multilayer structure having excellent oxygen gas barrier properties, a method of production thereof, and packaging materials including same, as well as papercoating agents, aqueous emulsions, adhesive agents, seed coating compositions, dispersion stabilizers for suspension polymerization of vinyl compounds, and auxiliary dispersion stabilizers for suspension polymerization of vinyl compounds. This makes it possible to save petroleum resources, and reduce carbon dioxide emissions in production processes, and, in turn, global warming.

The present invention can also provide a sealing agent for underground treatment comprising a vinyl alcohol polymer (PVA) having no appearance defects. The present invention can also provide a multilayer structure that exhibits excellent gas barrier properties under high humidity, and a packaging material including such a multilayer structure.

### DESCRIPTION OF EMBODIMENTS

The following describes embodiments of the present invention.

### Vinyl Alcohol Polymer (X)

A vinyl alcohol polymer (X) of the present invention is a vinyl alcohol polymer (X) (hereinafter, also referred to with the abbreviation “PVA (X)”) obtained through saponification after polymerization of a plant-derived vinyl ester monomer (A) and a petroleum-derived vinyl ester monomer (B), and has a mole ratio (A)/(B) of 5/95 to 100/0.

As used herein, “plant-derived vinyl ester monomer (A)” (hereinafter, also referred to simply as “vinyl ester monomer (A)”) refers to a vinyl ester monomer derived from biomass (nonfossil material), specifically, a vinyl ester monomer (preferably, vinyl acetate) obtained through a reaction of lower carboxylic acid, such as acetic acid, with ethylene obtained by using a plant raw material such as sugarcane or corn (hereinafter, also referred to as “bio-ethylene”). The biomass may be a single nonfossil material, or a mixture of nonfossil materials. Examples include cellulosic crops (such as pulp, kenaf, wheat straw, rice straw, used paper, and paper residue), wood, wood charcoal, compost, natural rubber, cotton, sugarcane, soy pulp, oils (such as canola oil, cottonseed oil, soy oil, coconut oil, and castor oil), carbohydrate crops (such as corn, potatoes, wheat, rice, husk, rice bran, old rice, cassava, and sago palm), bagasse, soba, soybean, essential oils (such as pine oil, orange oil, and eucalyptus oil), pulp black liquor, and vegetable oil cake. The biomass is not limited to biofuel crops, and includes, for example, agricultural residues, municipal solid wastes, industrial wastes, deposits in papermaking industry, pasture wastes, and wood or forest wastes. As a more specific example, brown sugar crystallized by heating and concentrating a juice extracted from sugarcane or corn is separated from the molasses by centrifugation, and the molasses is diluted with water to an appropriate concentration. After fermentation with yeast to generate ethanol (bioethanol), the bioethanol is heated to produce ethylene through intramolecular dehydration reaction in the presence of a catalyst. In another example, pulp black liquor is treated with an acid or an enzyme or the like to generate ethanol (bioethanol) and obtain ethylene in the same fashion. As used herein, “petroleum-derived vinyl ester monomer (B)” (hereinafter, also referred to simply as “vinyl ester monomer (B)”) refers to a vinyl ester monomer obtained by using common naphtha-derived ethylene as a raw material.

The PVA (X) is synthesized by saponifying a vinyl ester polymer obtained by polymerization of the plant-derived vinyl ester monomer (A) and the petroleum-derived vinyl ester monomer (B).

The method of polymerization of the vinyl ester monomers may be, for example, bulk polymerization, solution polymerization, suspension polymerization, emulsion polymerization, or dispersion polymerization. From an industry viewpoint, the method of polymerization is preferably solution polymerization, emulsion polymerization, or dispersion polymerization. The vinyl ester monomers may be polymerized by a batch, semi-batch, or continuous process.

Examples of the vinyl ester monomers (vinyl ester monomer (A) and vinyl ester monomer (B)) include vinyl acetate, vinyl formate, vinyl propionate, vinyl caprylate, and vinyl versatate. From an industry viewpoint, vinyl acetate is preferred. The vinyl ester monomer (A) and vinyl ester monomer (B) may be the same compounds (for example, vinyl acetate), or different compounds. That is, PVA (X) may be a homopolymer of one kind of vinyl ester monomer, or a copolymer of different vinyl ester monomers.

The polymerization initiator used for polymerization is selected from known polymerization initiators, for example, azo initiators, peroxide initiators, and redox initiators, according to the method of polymerization. Examples of the azo initiators include 2,2′-azobis(isobutyronitrile), 2,2′-azobis(2,4-dimethylvaleronitrile), and 2,2′-azobis(4-methoxy-2,4-dimethylvaleronitrile). Examples of the peroxide initiators include peroxydicarbonate compounds such as diisopropylperoxydicarbonate, di(2-ethylhexyl)peroxydicarbonate, and diethoxyethylperoxydicarbonate, perester compounds such as t-butylperoxyneodecanoate, and a-cumylperoxyneodecanoate; acetylcyclohexylsulfonylperoxide; and 2,4,4-trimethylpentyl-2-peroxyphenoxyacetate. The polymerization initiator may be a combination of these initiators with potassium persulfate, ammonium persulfate, hydrogen peroxide, or the like. The redox initiators are polymerization initiators combining, for example, a peroxide initiator such as above or an oxidizing agent (e.g., potassium persulfate, ammonium persulfate, hydrogen peroxide) with a reducing agent such as sodium bisulfite, sodium bicarbonate, tartaric acid, L-ascorbic acid, or rongalite. The amount of polymerization initiator used depends on the polymerization catalyst, and cannot be stated unconditionally. However, the amount is selected according to the polymerization rate.

The PVA (X) may be a product of saponification of a vinyl ester copolymer obtained by copolymerization of vinyl ester monomers (vinyl ester monomer (A) and vinyl ester monomer (B)) and other copolymerizable unsaturated monomers, as long as it does not hinder the intent and purpose of the present invention. Examples of such other unsaturated monomers include:
α-olefins such as ethylene, propylene, n-butene, and isobutylene;
acrylic acid and salts thereof;
acrylic acid esters such as methyl acrylate, ethyl acrylate, n-propyl acrylate, i-propyl acrylate, n-butyl acrylate, i-butyl acrylate, t-butyl acrylate, 2-ethylhexyl acrylate, dodecyl acrylate, and octadecyl acrylate;
methacrylic acid and salts thereof;
methacrylic acid esters such as methyl methacrylate, ethyl methacrylate, n-propyl methacrylate, i-propyl methacrylate, n-butyl methacrylate, i-butyl methacrylate, t-butyl methacrylate, 2-ethylhexyl methacrylate, dodecyl methacrylate, and octadecyl methacrylate;
acrylamide;
derivatives of acrylamide, such as N-methylacrylamide, N-ethylacrylamide, N,N-dimethylacrylamide, diacetoneacrylamide, acrylamidopropanesulfonic acid and salts thereof, acrylamidopropyldimethylamine and salts or quaternary salts thereof, and N-methylolacrylamide and derivatives thereof;
methacrylamide;
derivatives of methacrylamide, such as N-methylmethacrylamide, N-ethylmethacrylamide, methacrylamidopropanesulfonic acid and salts thereof, methacrylamidopropyldimethylamine and salts or quaternary salts thereof, and N-methylolmethacrylamide and derivatives thereof;
vinyl ethers such as methyl vinyl ether, ethyl vinyl ether, n-propyl vinyl ether, i-propyl vinyl ether, n-butyl vinyl ether, i-butyl vinyl ether, t-butyl vinyl ether, dodecyl vinyl ether, and stearyl vinyl ether;
nitriles such as acrylonitrile and methacrylonitrile;
vinyl halides such as vinyl chloride and vinyl fluoride;
vinylidene halides such as vinylidene chloride and vinylidene fluoride;
allyl compounds such as allyl acetate and allyl chloride;
unsaturated dicarboxylic acids such as maleic acid, itaconic acid, and fumaric acid, and salts or monoalkyl or dialkyl esters thereof;
vinyl silyl compounds such as vinyltrimethoxysilane; and
isopropenyl acetate.
One of these monomers, or two or more of these monomers may be copolymerized. A PVA having such a copolymerized component may be called “modified PVA”.

The unsaturated monomer as a component copolymerized with the vinyl ester monomers may preferably be ethylene in particular. That is, it may be preferable that the PVA (X) additionally contains an ethylene unit. When the PVA (X) additionally contains an ethylene unit, the lower limit of ethylene unit content is more than 0 mol %, and less than 20 mol %. The ethylene unit content is more preferably 1.5 mol % or more, even more preferably 2 mol % or more. The ethylene unit content is preferably 15 mol % or less, more preferably 10 mol % or less, even more preferably 8.5 mol % or less. When using ethylene as a copolymerized component, the ethylene may be one produced from a common petroleum-derived raw material or bioethanol (such as the ones described above), or may be a mixture of these.

When used for additives for slurries, drilling muds, or cement slurries, the PVA (X) is particularly preferably one obtained after copolymerization of vinyl ester monomer (A) and vinyl ester monomer (B) with ethylene. By copolymerizing the vinyl esters with ethylene, the PVA (X) after saponification can have a reduced solubility. This makes it possible to reduce dehydration from slurry at high temperature, or further reduce the viscosity increase of slurry.

When the PVA (X) is used for additives for slurries, drilling muds, or cement slurries, the ethylene unit content in PVA (X) is preferably less than 10 mol %, more preferably less than 9 mol %, even more preferably less than 8 mol % of all the structural units of PVA (X), in order to provide properties comparable or even superior to vinyl alcohol polymers derived solely from petroleum. When the PVA (X) is a copolymer containing an ethylene unit in its structural units, the lower limit of ethylene unit content is more than 0 mol %, and may be 0.1 mol % or more, or 1 mol % or more.

The ethylene unit content of PVA (X) is a value determined by ¹H-NMR measurement of a vinyl ester polymer, a precursor of PVA (X). Specifically, the precursor vinyl ester polymer is thoroughly purified by reprecipitation at least three times with a mixed solution of n-hexane and acetone, and dried under reduced pressure at 80° C. for 3 days to prepare a vinyl ester polymer to be used for analysis. The vinyl ester polymer is measured at 80° C. with a ¹H-NMR measurement device (JEOL GX-500, 500 MHz) after being dissolved in DMSO-d₆. The ethylene unit content is then calculated from a peak (integration value P: 4.7 ppm to 5.2 ppm) derived from the backbone methine of vinyl ester, and peaks (integration value Q: 0.8 ppm to 1.6 ppm) derived from the backbone methylene of ethylene, vinyl ester, and a third component.

Ethylene unit content (mol %)=100×((Q−2P)/4)/P

As described above, the PVA (X) may be one obtained through copolymerization of the vinyl ester monomers with other unsaturated monomers copolymerizable with vinyl ester monomers. A PVA (X) obtained through copolymerization with an unsaturated monomer such as an unsaturated monocarboxylic acid, an unsaturated dicarboxylic acid, or a salt or monoalkyl or dialkyl ester thereof has a structural unit containing carboxylic acid. Such a PVA (X) has even superior water solubility, and more adequately dissolves when used as a sealing agent for underground treatment, a papercoating agent, a seed coating composition, ora dispersion stabilizer for suspension polymerization of vinyl compounds. This is preferable in terms of reducing the burden placed on the environment.

In applications as a sealing agent for underground treatment, a papercoating agent, a seed coating composition, or a dispersion stabilizer for suspension polymerization of vinyl compounds, the PVA (X) has a degree of modification of preferably 0.5 mol % or more and 10 mol % or less, more preferably 0.7 mol % or more and 8 mol % or less, even more preferably 1.0 mol % or more and 5 mol % or less when it is a modified PVA, where the degree of modification specifically represents the content of structural units derived from other unsaturated monomers copolymerizable with vinyl ester monomers, relative to all the structural units constituting the modified PVA.

The degree of modification of a modified PVA can be determined from a ¹H-NMR spectrum (solvent: DMSO-d₆, internal standard: tetramethylsilane) of a PVA resin having a degree of saponification of 100 mol %. Specifically, the degree of modification can be calculated from peak areas derived from, for example, the hydroxyl protons, methine protons, and methylene protons of the modifying group, the methylene protons of the backbone, and the protons of hydroxyl groups attached to the backbone.

In applications as a papercoating agent, a multilayer structure or a packaging material using same, or an aqueous emulsion or an adhesive agent using same, the unsaturated monomer as a component copolymerized with the vinyl ester monomers is preferably ethylene in particular. The ethylene unit content of a PVA (X) containing ethylene units is preferably 1 mol % or more and less than 20 mol %. With an ethylene unit content of 1 mol % or more, the PVA (X) obtained can exhibit even superior gas barrier properties. The ethylene unit content is more preferably 1.5 mol % or more, even more preferably 2 mol % or more. With an ethylene unit content of less than 20 mol %, the PVA (X) can have adequate water solubility, and can more easily be prepared into an aqueous solution. The ethylene unit content is preferably 15 mol % or less, more preferably 10 mol % or less, even more preferably 8.5 mol % or less. When using ethylene as a copolymerized component, the ethylene may be one produced from a common petroleum-derived raw material or bioethanol (such as the ones described above), or may be a mixture of these. When the PVA (X) is a copolymer containing an ethylene unit in its structural units, the lower limit of ethylene unit content is more than 0 mol %, and may be 0.1 mol % or more, or 1 mol % or more.

In polymerization of vinyl ester monomer (A) and vinyl ester monomer (B), a chain transfer agent may be present to adjust the degree of polymerization of PVA (X). Examples of the chain transfer agent include aldehydes such as acetaldehyde, propionaldehyde, butylaldehyde, and benzaldehyde; ketones such as acetone, methyl ethyl ketone, hexanone, and cyclohexanone; mercaptans such as 2-hydroxyethanethiol; thiocarboxylic acids such as 3-mercaptopropionic acid and thioacetic acid; and halogenated hydrocarbons such as trichloroethylene and perchloroethylene. Preferred are aldehydes or ketones. The chain transfer agent may be added in an amount that depends on factors such as the chain transfer constant of the chain transfer agent, and the desired degree of polymerization of PVA.

The saponification reaction of the vinyl ester polymer can be achieved by an alcoholysis or hydrolysis reaction using a known basic catalyst such as sodium hydroxide, potassium hydroxide, or sodium methoxide, or a known acid catalyst such as p-toluenesulfonic acid.

Examples of the solvent that can be used for the saponification reaction include alcohols such as methanol and ethanol; esters such as methyl acetate and ethyl acetate; ketones such as acetone, and methyl ethyl ketone; and aromatic hydrocarbons such as benzene and toluene. These may be used alone, or two or more thereof may be used in combination. For convenience, it is preferable that the saponification reaction be carried out in the presence of basic catalyst sodium hydroxide, using methanol or a mixed solution of methanol and methyl acetate as a solvent.

### Degree of Saponification

In applications as an additive for slurries, a drilling mud, or a cement slurry, the PVA (X) has a degree of saponification of preferably 99 mol % or more, more preferably 99.5 mol % or more. A PVA is a crystalline polymer having a crystal moiety due to hydrogen bonding of the hydroxyl group contained. The crystallinity of PVA (X) improves with increasing degree of saponification, and the water solubility of PVA (X) decreases as the crystallinity improves. Particularly, the solubility of PVA (X) in hot water shows a large change once the degree of saponification exceeds 99.5 mol %. Accordingly, a PVA (X) having a degree of saponification of 99.5 mol % or more can have high water resistance (low solubility) because of the strong hydrogen bond, even comparable to the water resistance of a PVA (X) having a chemical crosslink. A PVA (X) having a degree of saponification of 99.5 mol % or more is therefore capable of reducing dehydration and viscosity increase of slurry, even in the absence of chemical crosslinking. This is advantageous because there is no cost associated with the chemical crosslinking step. In applications as an additive for cement slurries, it may not be possible to sufficiently reduce dehydration at high temperature when the degree of saponification is low.

The degree of saponification of PVA (X) is a value measured according to JIS K 6726:1994.

In applications as a sealing agent for underground treatment, or a papercoating agent, the degree of saponification of PVA (X) is preferably 90 mol % or more, more preferably 98 mol % or more, even more preferably 99 mol % or more, particularly preferably 99.5 mol % or more. A PVA is a crystalline polymer having a crystal moiety due to hydrogen bonding of the hydroxyl group contained. The crystallinity of PVA (X) improves with increasing degree of saponification, and the water solubility of PVA (X) decreases as the crystallinity improves.

In applications as a multilayer structure or a packaging material using same, the degree of saponification of PVA (X) is not particularly limited, and is preferably 80 to 99.99 mol %. With a degree of saponification of 80 mol % or more, the multilayer structure obtained can exhibit even superior oxygen gas barrier properties. The degree of saponification is more preferably 85 mol % or more, even more preferably 90 mol % or more. The PVA (X) can be stably produced when the degree of saponification is 99.99 mol % or less. The degree of saponification is more preferably 99.5 mol % or less, even more preferably 99 mol % or less, particularly preferably 98.5 mol % or less.

In applications as a seed coating composition, the degree of saponification of PVA (X) is preferably 65 mol % or more, more preferably 67 mol % or more, even more preferably 69 mol % or more, particularly preferably 70 mol % or more. With a degree of saponification of 60 mol % or more, the PVA (X) can exhibit even superior water solubility. This is more advantageous for the production of a seed coating composition.

In applications as an aqueous emulsion or an adhesive agent using same, the degree of saponification of PVA (X) is not particularly limited, and is preferably 80 to 99.99 mol %. With a degree of saponification of 80 mol % or more, it may be possible to achieve even more desirable stability by further reducing aggregation of particles in an aqueous emulsion during storage. The degree of saponification is more preferably 82 mol % or more, even more preferably 85 mol % or more. With a degree of saponification of 99.99 mol % or less, the particles in an aqueous emulsion tend to be more stable, and enable easier production. The degree of saponification is more preferably 99.5 mol % or less, even more preferably 99 mol % or less, particularly preferably 98.5 mol % or less.

In applications as a dispersion stabilizer for suspension polymerization of vinyl compounds, the degree of saponification of PVA (X) is preferably 60 mol % or more and 99.5 mol % or less, more preferably 65 mol % or more and 99.2 mol % or less, even more preferably 68 mol % or more and 99.0 mol % or less. With a degree of saponification of 60 mol % or more, the PVA (X) can exhibit excellent water solubility, making it easier to prepare an aqueous solution of a dispersion stabilizer. With a degree of saponification of 99.5 mol % or less, it is possible to further reduce formation of a large number of coarse particles when suspension polymerization is performed with the dispersant obtained. It may also be possible to improve plasticizer absorbability by increasing the porosity of the vinyl polymer particles obtained.

In applications as an auxiliary dispersion stabilizer for suspension polymerization of vinyl compounds, the degree of saponification of PVA (X) is 20 mol % or more and less than 60 mol %, preferably 25 mol % or more and 58 mol % or less, more preferably 30 mol % or more and 56 mol % or less. Production of PVA (X) is difficult with a degree of saponification of 20 mol % or less. With a degree of saponification of 60 mol % or more, difficulty may arise in removing the monomer components from the vinyl polymer particles resulting from the suspension polymerization of vinyl compounds, or the plasticizer absorbability of the vinyl polymer particles obtained may decrease.

### Degree of Polymerization

In applications as an additive for slurries, a drilling mud, or a cement slurry, the PVA (X) has a degree of polymerization of preferably 1,500 or more and 4,500 or less, more preferably 2,000 or more and 3,800 or less. With the PVA (X) having a degree of polymerization of 4,500 or less, an appropriate viscosity can be obtained even at high temperature when the PVA (X) is used as an additive for cement slurries. With the PVA (X) having a degree of polymerization of 1,500 or more, dehydration can be sufficiently reduced even at high temperature.

In applications as a sealing agent for underground treatment, a papercoating agent, a seed coating composition, or a dispersion stabilizer for suspension polymerization of vinyl compounds, the PVA (X) has a degree of polymerization of preferably 150 or more and 5,000 or less, more preferably 300 or more and 4,000 or less, even more preferably 500 or more and 3,500 or less. Having a degree of polymerization of 5,000 or less is industrially advantageous for production of PVA (X). In applications as a sealing agent for underground treatment, a more appropriate sealing effect can be obtained when the PVA (X) has a degree of polymerization of 150 or more. In applications as a papercoating agent, more appropriate waterproofing strength can be imparted to coated paper when the PVA (X) has a degree of polymerization of 150 or more. In applications as a seed coating composition, an even superior effect can be produced by coating when the PVA (X) has a degree of polymerization of 150 or more. Having a degree of polymerization of 150 or more is more advantageous for production of PVA (X), and a PVA(X) having degree of polymerization of 150 or more is more capable as a dispersion stabilizer for suspension polymerization.

In applications as a multilayer structure or a packaging material using same, the PVA (X) has a degree of polymerization of preferably 150 or more and 5,000 or less, more preferably 200 or more and 5,000 or less. Having a degree of polymerization of 150 or more is more advantageous for production of a multilayer structure. The degree of polymerization is more preferably 250 or more, even more preferably 300 or more, particularly preferably 400 or more. With the PVA (X) having a degree of polymerization of 5,000 or less, the viscosity of the aqueous solution does not overly increase, and ease of handling can improve even more greatly. The PVA (X) has a degree of polymerization of more preferably 4,500 or less, even more preferably 4,000 or less, particularly preferably 3,500 or less.

In applications as a papercoating agent, the PVA (X) has a degree of polymerization of preferably 150 or more and 5,000 or less, more preferably 300 or more and 4,000 or less. Having a degree of polymerization of 5,000 or less is more advantageous for production of PVA (X). With the PVA (X) having a degree of polymerization of 150 or more, more appropriate waterproofing strength can be imparted to coated paper.

In applications as an aqueous emulsion or an adhesive agent using same, the PVA (X) has a degree of polymerization of preferably 150 or more and 5,000 or less, more preferably 200 or more and 5,000 or less. With the PVA (X) having a degree of polymerization of 150 or more, the aqueous emulsion obtained can have more desirable storage stability. The degree of polymerization is more preferably 250 or more, even more preferably 300 or more, particularly preferably 400 or more. With the PVA (X) having a degree of polymerization of 5,000 or less, the viscosity of the aqueous solution does not overly increase, and ease of handling can improve even more greatly. The PVA (X) has a degree of polymerization of more preferably 4,500 or less, even more preferably 4,000 or less, particularly preferably 3,500 or less.

In applications as an auxiliary dispersion stabilizer for suspension polymerization of vinyl compounds, the PVA (X) has a degree of polymerization of preferably 100 or more and 700 or less, more preferably 120 or more and 650 or less, even more preferably 150 or more and 600 or less. The PVA (X) having a degree of polymerization of 700 or less excels in ease of handling by allowing easier removal of monomer components from the vinyl polymer particles resulting from the suspension polymerization of vinyl compounds, improving the plasticizer absorbability of the vinyl polymer particles obtained, or reducing an excessive viscosity increase when provided as a high-concentration aqueous solution of an auxiliary dispersion stabilizer. Having a degree of polymerization of 100 or more is more advantageous for production of PVA (X).

The degree of polymerization (viscosity-average degree of polymerization) of PVA (X) is a value measured according to JIS K 6726:1994. Specifically, the degree of polymerization of PVA can be determined from the limiting viscosity [η] (dL/g) measured in 30° C. water, using the following formula.

Degree of polymerization=([η]×100018.29)^{(1/10.62)}

In the present invention, the mole ratio (A)/(B) of plant-derived vinyl ester monomer (A) to petroleum-derived vinyl ester monomer (B) in vinyl alcohol polymer (X) is 5/95 to 100/0 because such a mole ratio produces the desired effects, and is industrially advantageous. The mole ratio (A)/(B) can be freely set. However, when the fraction of (A) is 5/95 or more in terms of a ratio of (A)/(B), the vinyl alcohol polymer (X) can have properties comparable or even superior to vinyl alcohol polymers derived solely from petroleum, and can exhibit an even greater environmental burden reducing effect by taking great advantage of the plant-derived raw material. In view of this, the lower-limit fraction of plant-derived vinyl ester monomer (A) is preferably 10/90, more preferably 20/80, even more preferably 25/75 in terms of a mole ratio (A)/(B). From a balance between environmental burden and raw material cost, the upper-limit fraction of plant-derived vinyl ester monomer (A) is preferably 90/10, more preferably 80/20, even more preferably 70/30, particularly preferably 60/40, most preferably 50/50 in terms of a mole ratio (A)/(B). For production, it is advantageous to have these upper limits for the fraction of plant-derived vinyl ester monomer (A) because the PVA (X) is less likely to face problems such as appearance defects due to cracking.

### Degree of Biomass

In the present invention, biomass-derived carbon means the carbon present in an organic material synthesized from a raw-material plant that has incorporated carbon from the carbon dioxide present in atmospheric air, and can be identified by measuring radiocarbon (carbon-14). The fraction of a biomass-derived component can be specified by measuring radiocarbon (carbon-14). Specifically, because the carbon in fossil materials such as petroleum is almost completely devoid of carbon-14 atoms, the fraction of biomass-derived carbon in the carbon contained in a sample of interest can be determined by measuring the concentration of carbon-14 in the sample, and calculating back the fraction using the carbon-14 fraction in atmospheric air (107 pMC; percent Modern Carbon) as an index.

The percentage presence of biomass-derived carbon by such radiocarbon measurement can be determined by, for example, measuring the carbon-14 content in a sample (vinyl ester) against a standard material (for example, US NIST oxalic acid) by accelerator mass spectrometry (AMS) after optionally preparing the sample into carbon dioxide or graphite. The fraction of biomass-derived carbon (%) can be calculated by [(amount of biomass-derived carbon in sample)/(total carbon amount in sample)×100].

The proportions of the nonfossil material and fossil material in a vinyl ester monomer can be found by measuring the ¹⁴C/C ratio, allowing the vinyl ester monomer to be differentiated from a vinyl ester monomer obtained from petroleum-derived ethylene.

When ethylene derived from biomass (nonfossil material) is used as a part of the raw material of a vinyl ester monomer, the proportion of the nonfossil material in the vinyl ester monomer can be specified by the ¹⁴C (radiocarbon)/C (carbon) ratio of the vinyl ester monomer obtained. Compared to the ¹⁴C/C ratio of less than 1.0×10⁻¹⁴ in a vinyl ester monomer obtained from fossil materials, the vinyl ester monomer (A) used in the present invention has a ¹⁴C/C ratio of preferably 1.0×10⁻¹⁴ or more, more preferably 1.0×10⁻¹³ or more, even more preferably 1.0×10⁻¹². For example, the ¹⁴C/C ratio can be determined by measuring the amount of carbon-14 (¹⁴C) against the ¹⁴C in the standard material oxalic acid developed by The National Institute of Standards and Technology. The fraction of nonfossil material in the vinyl ester monomer can then be measured by analyzing the amount of carbon from ¹⁴C/C.

Nuclear testing in the atmosphere has created a non-natural source of ¹⁴C in nature, increasing the ¹⁴C concentration slightly higher than the standard level, sometimes a little over 100 pMC. However, the proportions of nonfossil material and fossil material can be determined by calibrating the ¹⁴C concentration as appropriate. Carbon-14 has a half-life of 5,730 years. However, a decrease of ¹⁴C is negligible considering the length of time while ordinary chemical products, specifically vinyl acetate, and vinyl acetate resins polymerized from vinyl acetate, and saponification products thereof are in the market after their production. In the present invention, pMC (percent modern carbon) notation may be used as appropriate to represent a ¹⁴C/C ratio when it is 1.0×10⁻¹⁴.

A PVA (X) of the present invention has a degree of biomass of 5 to 90%. Measurement of degree of biomass can be useful for tracing of carbon raw materials used in products.

When the PVA (X) contains a copolymerized component such as ethylene, the degree of biomass is represented as including the copolymerized component. However, the percentage of a nonfossil material as a vinyl ester monomer can be determined by calculations from the identity of the material of the copolymerized component and the degree of modification of the copolymerized component.

### Additive for Slurries

An additive for slurries of the present invention comprises a vinyl alcohol polymer (X) obtained through saponification after polymerization of a plant-derived vinyl ester monomer (A) and a petroleum-derived vinyl ester monomer (B), and has a mole ratio (A)/(B) of 5/95 to 100/0. A drilling mud of the present invention comprises a vinyl alcohol polymer (X) obtained through saponification after polymerization of a plant-derived vinyl ester monomer (A) and a petroleum-derived vinyl ester monomer (B), and has a mole ratio (A)/(B) of 5/95 to 100/0. A cement slurry of the present invention comprises the additive for slurries.

An additive for slurries of the present invention can be used as an additive for drilling mud slurries, or an additive for cement slurries. The additive for slurries comprises the PVA (X). The additive for slurries comprises the PVA (X) in powder form (such a powdery PVA (X) will also be referred to as “PVA powder”). The additive for slurries may comprise only the PVA powder, or may comprise an optional component in addition to the PVA powder. The content of the PVA powder in the additive for slurries is, for example, 50 mass % or more and 100 mass % or less, preferably 80 mass % or more and 100 mass % or less.

Preferably, the PVA powder has a particle size that passes through a sieve having a nominal opening of 1.00 mm (16 mesh). With such a PVA powder contained as an additive in a slurry such as a drilling mud or a cement slurry, it is easier to reduce dehydration from the slurry at high temperature. The lower limit of the particle size of the PVA powder is a value that prevents the solubility from becoming excessively high.

Preferably, the PVA powder has a particle size that does not pass through a nominal opening of 45 μm (325 mesh), more preferably a particle size that does not pass through a nominal opening of 53 μm (280 mesh).

### Drilling Mud

The roles of a drilling mud of the present invention include, for example, carrying drill cuttings such as rock fragments and drill dust, improving the lubricity of bits or drill pipes, burying pores in porous ground, and balancing the reservoir pressure (the pressure of rock) created by hydrostatic pressure. The drilling mud comprises the additive for slurries, and water and a clay material contained as main components. The drilling mud may comprise an optional component, provided that it does not hinder the intent and purpose of the present invention.

A drilling mud of the present invention comprises the PVA (X). A preferred embodiment is, for example, a drilling mud that comprises the PVA (X), water, and a clay material. Such a drilling mud is produced by mixing a clay material, water, and the additive for slurries. Specifically, the drilling mud can be produced by adding the additive for slurries, and additionally, an optional component to a base water-clay suspension prepared by dispersing and suspending a clay material in water.

### Additive for Drilling Mud Slurries

A preferred embodiment is, for example, a drilling mud comprising an additive for drilling mud slurries. The additive for drilling mud slurries comprises the PVA powder. The additive for drilling mud slurries may comprise only the PVA powder. A certain preferred embodiment is, for example, a drilling mud comprising the PVA (X), water, and bentonite. The PVA (X) and the PVA powder are as described above, and explanations thereof are omitted here.

In the drilling mud, it is preferable that the PVA powder have a particle size that passes through a sieve having a nominal opening (JIS Z 8801-1:2019) of 1.00 mm (16 mesh), more preferably a particle size that passes through a sieve having a nominal opening of 500 μm (32 mesh). With a PVA powder particle size that passes through a sieve having a nominal opening of 500 μm (32 mesh), dehydration from the drilling mud at high temperature can be reduced even more greatly when the drilling mud contains a PVA powder having such a particle size. The lower limit of the particle size of the PVA powder is not particularly limited, as long as it prevents the solubility from becoming excessively high. Preferably, the PVA powder has a particle size that does not pass through a nominal opening of 45 μm (325 mesh), more preferably a particle size that does not pass through a nominal opening of 53 μm (280 mesh).

The content of the PVA powder in the drilling mud is preferably 0.5 kg/m³ or more and 40 kg/m³ or less, more preferably 3 kg/m³ or more and 30 kg/m³ or less.

### Clay Material

Examples of the clay material include bentonite, attapulgite, selenite, and hydrated magnesium silicate. Preferably, the clay material is bentonite.

The clay material is added to the drilling mud in an amount of preferably 5 g to 300 g, more preferably 10 g to 200 g per kilogram of water used for the drilling mud.

### Optional Components

The optional components may be known additives, for example, such as an aqueous solution of a copolymer of a C2 to C12 α-olefin and maleic anhydride, or a derivative thereof (for example, maleamide, maleimide), or an aqueous solution of an alkali neutralized product thereof. Other examples include dispersants, pH adjusters, antifoaming agents, and thickeners. Examples of the copolymer of a C2 to C12 α-olefin and maleic anhydride, or a derivative thereof include copolymers of maleic anhydride and an α-olefin such as ethylene, propylene, butene-1, isobutene, or diisobutylene, and derivatives thereof (for example, Isobam from Kuraray). Examples of the dispersants include humic acid-based dispersants, and lignin-based dispersants. Preferred are lignin-based dispersants containing sulfonate.

### Cement Slurry

A cement slurry of the present invention is used by, for example, being injected and hardened in the annular space between the stratum and a casing pipe installed in the wellbore, in order to secure the casing pipe in the well, or to protect the inner wall in the well. The cement slurry comprises the additive for slurries, a hardening powder, and a liquid. The cement slurry may additionally comprise an optional component, provided such additional components do not interfere with the effects of the present invention.

The cement slurry is produced by adding and mixing the additive for slurries, a liquid, a hardening powder, and, additionally, an optional component, using a stirrer or the like.

### Additive for Cement Slurries

A certain preferred embodiment is, for example, a cement slurry comprising an additive for cement slurries. The additive for cement slurries comprises the PVA powder. The additive for cement slurries may comprise only the PVA powder. A certain preferred embodiment is, for example, a drilling mud comprising the PVA (X), a liquid, and a hardening powder. The PVA and PVA powder are as described above, and explanations thereof are omitted here.

In the cement slurry, the PVA powder preferably has a particle size that passes through a sieve having a nominal opening of 1.00 mm (16 mesh), more preferably a particle size that passes through a sieve having a nominal opening of 250 μm (60 mesh). With a PVA powder particle size that passes through a sieve having a nominal opening of 250 μm (60 mesh), dehydration from the cement slurry at high temperature can be reduced even more greatly when the cement slurry contains a PVA powder having such a particle size. The lower limit of the particle size of the PVA powder is not particularly limited, as long as it prevents the solubility from becoming excessively high. Preferably, the PVA powder has a particle size that does not pass through a nominal opening of 45 μm (325 mesh), more preferably a particle size that does not pass through a nominal opening of 53 μm (280 mesh).

The content of the PVA powder in the cement slurry is preferably 0.1% (BWOC) or more and 2.0% (BWOC) or less, more preferably 0.2% (BWOC) or more and 1.0% (BWOC) or less. Here, “BWOC” (By Weight Of Cement) means an amount by weight of cement.

### Hardening Powder

Examples of the hardening powder include portland cement, blended cements, eco-cements, and special cements. Preferably, the hardening powder is a hydraulic cement that solidifies by reacting with water. Geothermal cements and oil-well cements are preferred when the cement slurry is used for drilling. The hardening powder may be used alone, or two or more thereof may be used in combination.

The portland cement may be the one specified by JIS R5210:2019. Specific examples of the portland cement include common portland cement, high early strength portland cement, very high early strength portland cement, moderate heat portland cement, low heat portland cement, sulfate resistant portland cement, and low-alkali portland cement.

Examples of the blended cements include those specified by JIS R 5211:2019, JIS R 5212:2019, and JIS R 5213:2019, specifically, blast furnace cement, silica cement, and fly ash cement.

The special cements include those based on portland cement, those modified from portland cement by varying the ingredients or particle size composition, and those differing in ingredient from portland cement.

Examples of the special cements based on portland cement include expansive cement, two-part low heat cement, and three-part low heat cement.

Examples of the special cements modified from portland cement by varying the ingredients and particle size composition include white portland cement, cement-based solidifiers (geocements), fine particle cement, and high belite cement.

Examples of the special cements differing in ingredient from portland cement include ultrarapid hardening cement, alumina cement, phosphate cement, and air-setting cement.

### Liquid

The liquid is selected according to factors such as the type of hardening powder, and may be, for example, water, a solvent, or a mixture of these. Typically, water is used. The solvent may be used alone, or two or more thereof may be used in combination.

The proportions of the hardening powder and liquid in the cement slurry can be decided as appropriate according to factors such as the desired specific gravity of slurry, or the strength of the hardening body. For example, in view of the specific gravity of slurry and the strength of hardening body, the water-to-cement ratio (W/C) is preferably 25 mass % or more and 100 mass % or less, more preferably 30 mass % or more and 80 mass % or less when the cement slurry is configured as a drilling cement slurry with a hydraulic cement.

### Optional Component

The optional component may contain a dispersant, a retardant, or an antifoaming agent. The optional component may also contain additives other than these. The optional component may be used alone, or two or more thereof may be used in combination.

### Dispersant

Examples of the dispersant include anionic polymers such as a naphthalene sulfonic acid formalin condensate, a melamine sulfonic acid formalin condensate, and polycarboxylic acid polymer. The dispersant is preferably a naphthalene sulfonic acid formalin condensate. The dispersant content is typically 0.05% (BWOC) or more and 2% (BWOC) or less, preferably 0.2% (BWOC) or more and 1% (BWOC) or less.

### Retardant

Examples of the retardant include oxycarboxylic acid or salts thereof, and sugars such as monosaccharides and polysaccharides. The retardant is preferably a sugar. The retardant content is typically 0.005% (BWOC) or more and 1% (BWOC) or less, preferably 0.02% (BWOC) or more and 0.3% (BWOC) or less.

### Antifoaming Agent

Examples of the antifoaming agent include alcohol alkylene oxide adduct, fatty acid alkylene oxide adduct, polypropylene glycol, fatty acid soap, and silicon-based compounds. The antifoaming agent is preferably a silicon-based compound. The content of antifoaming agent is typically 0.0001% (BWOC) or more and 0.1% (BWOC) or less, preferably 0.001% (BWOC) or more and 0.05% (BWOC) or less.

### Additives

Taking into account factors such as use and composition, the cement slurry may contain additives, for example, such as a cement accelerator, a low-specific-gravity additive, a high-specific-gravity additive, a blowing agent, a crack reducing agent, a foaming agent, an AE agent, a cement expansive material, a cement strength stabilizer, a silica stone powder, silica fume, fly ash, a limestone powder, a fine aggregate such as crushed sand, a coarse aggregate such as crushed stone, and hollow balloons. These additives may be used alone, or two or more thereof may be used in combination.

### Sealing Agent for Underground Treatment

A sealing agent for underground treatment of the present invention comprises a vinyl alcohol polymer (X) obtained through saponification after polymerization of a plant-derived vinyl ester monomer (A) and a petroleum-derived vinyl ester monomer (B), and has a mole ratio (A)/(B) of 5/95 to 90/10.

A sealing agent for underground treatment of the present invention comprises the PVA (X). The content of PVA (X) is not particularly limited, and is preferably 50 to 100 mass %, more preferably 80 to 100 mass %, even more preferably 90 to 100 mass % relative to the whole sealing agent for underground treatment. The sealing agent for underground treatment tends to produce an even superior sealing effect with the PVA (X) content confined in these ranges.

In drilling of resources such as petroleum and shale gas, a sealing agent for underground treatment of the present invention can create new fractures by entering and temporarily plugging the fractures formed. Plugging of fractures with a sealing agent for underground treatment of the present invention may be achieved by allowing the sealing agent for underground treatment to flow into fractures in need of plugging, together with the fluid flowing into the wellbore.

Despite its ability to temporarily plug underground fractures, a sealing agent for underground treatment of the present invention does not stay underground for prolonged time periods because it gradually dissolves in water, and becomes removed while or after an underground resource such as petroleum or natural gas is collected. That is, a sealing agent for underground treatment of the present invention places a very small burden on the environment.

The shape of the PVA (X) used for the sealing agent for underground treatment is not particularly limited, and the PVA (X) may have a shape of a pellet, a granule, or a powder. Ordinary methods such as extrusion may be used to form pellets. For this purpose, a plasticizer such as polyethylene glycol may be added as appropriate, as will be described later.

When the PVA (X) used for the sealing agent for underground treatment is powdery in shape, the average particle diameter is preferably 10 to 5,000 μm, more preferably 50 to 4,000 μm, even more preferably 100 to 3,500 μm, particularly preferably 500 to 3,000 μm.

With the average particle diameter of PVA (X) confined in these ranges, there is no scattering of PVA resin, and ease of handling improves even more greatly. A more uniform and desirable reaction also tends to occur even when, for example, the PVA (X) is modified later. Here, “average particle diameter” is the diameter at 50% of cumulative values (cumulative distribution) in a laser diffraction measurement of a volume distribution per particle size. As a specific example of a laser diffraction scattering method, the particle size may be measured by volume with a laser diffraction particle size distribution analyzer (SALD-2300; Shimadzu Corporation), using a 0.2% sodium hexametaphosphate aqueous solution used as dispersion medium.

A sealing agent for underground treatment of the present invention may additionally comprise an additive. Examples of the additive include fillers, plasticizers, and starches. The additive may be used alone, or two or more thereof may be used in combination.

By being mixed with PVA (X), a filler can further improve mechanical characteristics, or can adjust the dissolution rate in water. The filler may be added in appropriately adjusted amounts, depending on intended use. For example, the amount of filler is preferably 50 mass % or less, more preferably 30 mass % or less, even more preferably 5 mass % or less of the whole sealing agent.

Preferably, the sealing agent for underground treatment has a specific gravity close to the specific gravity of the fluid used for underground treatment. In this way, for example, the sealing agent can be uniformly sent into the system by pumping. In view of adjusting the specific gravity of the sealing agent for underground treatment, a weighting agent may be added to PVA (X). The PVA (X) can have an increased specific gravity with addition of a weighting agent. Examples of the weighting agent include natural minerals, and salts of inorganic and organic materials. For example, the weighting agent may be a compound combining one metal ion or two or more metal ions selected from the group consisting of calcium, magnesium, silicon, barium, copper, zinc, and manganese with one counter ion or two or more counter ions selected from the group consisting of a fluoride, a chloride, a bromide, a carbonate, a hydroxide, a formate, an acetate, a nitrate, a sulfate, and a phosphate. Preferred are calcium carbonate, calcium chloride, and zinc oxide, for example.

In order to improve the fluid properties of the sealing agent for underground treatment, the sealing agent for underground treatment may comprise a plasticizer, in addition to the PVA (X). In other words, a plasticizer may be added and mixed with PVA (X). In this case, a plasticizer may be sprayed to coat the surface of PVA (X) for uniform addition to the PVA (X). By adding a plasticizer, it may be possible to further reduce generation of a fine powder. The plasticizer may be a known plasticizer. Examples of the preferred plasticizer include water, glycerol, polyglycerol, ethylene glycol, polyethylene glycol, ethanolacetamide, ethanolformamide, triethanolamine acetate, glycerin, trimethylolpropane, and neopentyl glycol. These may be used alone, or two or more thereof may be used in combination. Plasticizers that are solid or crystalline at ordinary temperature (such as trimethylolpropane) can be used for spray coating after being dissolved in water or other liquids. The plasticizer content is preferably 40 mass % or less, more preferably 30 mass % or less, even more preferably mass % or less based on the mass of PVA (X) (100 mass %).

A certain preferred embodiment is, for example, a sealing agent for underground treatment that comprises a composition combining the PVA (X) and an additive, and in which the additive contains a filler and a plasticizer. The fraction of each component added in the sealing agent for underground treatment is preferably 60 to 94 mass % for PVA (X), 5 to 40 mass % for the filler, and 1 to 15 mass % for the plasticizer.

In a sealing agent for underground treatment of the present invention, the PVA (X) may be mixed with starch. The starch is added in an amount of preferably 10 to 90 mass %, more preferably 30 mass % or more relative to the PVA (X) at 100 mass %. Examples of the starch include natural products, synthetic products, and physically or chemically modified starches.

Additionally, a sealing agent for underground treatment of the present invention may optionally comprise an additive such as a chelating agent, a pH adjuster, an oxidizing agent, a lost-circulation material, a scale preventing agent, a rust inhibitor, a clay, an iron formulation, a reducing agent, or an oxygen scavenger.

### Multilayer Structure

A multilayer structure of the present invention comprises: a layer (C) comprising a vinyl alcohol polymer (X) obtained through saponification after polymerization of a plant-derived vinyl ester monomer (A) and a petroleum-derived vinyl ester monomer (B); and a layer (D) comprising a resin, the resin being at least one selected from the group consisting of a polyolefin resin, a polyester resin, a polyamide resin, a polyvinyl chloride (PVC) resin, an ABS resin, a polylactic acid (PLA) resin, a polybutylene succinate (PBS) resin, a polyhydroxyalkanoate (PHA) resin, a polyhydroxybutyrate/hydroxyhexanoate (PHBH) resin, a starch, and a cellulose.

### Layer (C)

The layer (C) constituting a multilayer structure of the present invention comprises the PVA (X).

The content of the PVA (X) in the layer (C) is preferably 50 mass % or more, more preferably 80 mass % or more, even more preferably 95 mass % or more. In layer (C), the mass ratio of the vinyl alcohol polymer with respect to all polymer components (vinyl alcohol polymer/all polymer components) is preferably 0.9 or more. More preferably, the polymer components in the layer (C) consist essentially of the PVA (X). When the polymer components consist essentially of the PVA (X), the content of components other than the PVA (X) is preferably less than 0.5 mass %, more preferably less than 0.1 mass %, even more preferably less than 0.01 mass %.

### Layer (D)

The layer (D) is a substrate comprising a resin. Examples of the resin include a polyolefin resin, a polyester resin, a polyamide resin, a polyvinyl chloride (PVC) resin, an ABS resin, a polylactic acid (PLA) resin, a polybutylene succinate (PBS) resin, a polyhydroxyalkanoate (PHA) resin, a polyhydroxybutyrate/hydroxyhexanoate (PHBH) resin, a starch and a cellulose. The resin may be used alone, or two or more thereof may be used in combination. The layer (D) has a thickness of preferably 5 to 100 μm (the final thickness when stretched).

Examples of the polyolefin resin include polyethylene, polypropylene, copolymerized polypropylene, an ethylene-vinyl acetate copolymer, and an ethylene-(meth)acrylic acid ester copolymer. Examples of the polyethylene include high-density polyethylene (HDPE), low-density polyethylene (LDPE), linear low-density polyethylene (LLDPE), and very low-density polyethylene (VLDPE). Preferred are polyethylene and polypropylene. As used herein, “(meth)acryl” collectively refers to acryl and methacryl. The same applies to similar expressions, such as “(meth)acrylate”.

Examples of the polyester resin include polyethylene terephthalate (hereinafter, also referred to with the abbreviation “PET”), polyethylene naphthalate, polybutylene terephthalate, and polyethylene terephthalate/isophthalate. Preferred is polyethylene terephthalate (PET).

Examples of the polyamide resin include:
homopolymers such as polycaproamide (nylon-6), polyundecaneamide (nylon-11), polylaurolactam (nylon-12), polyhexamethylene adipamide (nylon-6,6), and polyhexamethylene sebacamide (nylon-6,12);
copolymers such as a caprolactam/laurolactam copolymer (nylon-6/12), a caprolactam/aminoundecanoic acid polymer (nylon-6/11), a caprolactam/ω-aminononanoic acid polymer (nylon-6,9), a caprolactam/hexamethylene diammonium adipate copolymer (nylon-6/6,6), a caprolactam/hexamethylene diammonium adipate/hexamethylene diammonium sebacate copolymer (nylon-6/6,6/6,12), a polymer of adipic acid and m-xylylenediamine, and a polymer of hexamethylenediamine and m,p-phthalic acid (such as aromatic nylon). Preferred are polycaproamide (nylon-6), and polyhexamethylene adipamide (nylon-6,6).

The polyvinyl chloride resin may be, for example, a homopolymer of vinyl chloride, or a copolymer of vinyl chloride and other monomer. Examples of such other monomer include:
α-olefins such as ethylene, propylene, and butylene;
dienes such as butadiene and isoprene;
vinyl esters such as vinyl acetate and vinyl propionate;
vinyl ethers such as butyl vinyl ether, and cetyl vinyl ether;
(meth)acrylic acid esters such as methyl (meth)acrylate, ethyl (meth)acrylate, butyl acrylate, phenyl methacrylate, and hydroxyethyl (meth)acrylate;
aromatic vinyls such as styrene, and a-methylstyrene;
vinyl halides such as vinylidene chloride, and vinylidene fluoride;
N-substituted maleimides such as N-phenylmaleimide, and N-cyclohexylmaleimide; and
(meth)acrylic acid, maleic anhydride, acrylonitrile, and polyorganosiloxane.
These may be used alone, or two or more thereof may be used in combination. The monomer copolymerizable with a vinyl chloride monomer is preferably 0 to 50 parts by mass with respect to total 100 parts by mass of vinyl chloride and the monomer copolymerizable with a vinyl chloride monomer.

Examples of the ABS (Acrylonitrile Butadiene Styrene) resin include those containing acrylonitrile, butadiene, and styrene as structural units. Examples include flame-retardant ABS resin, reinforced ABS resin (such as glass fiber-reinforced ABS resin), and phenylmaleimide ABS resin. Other examples of the ABS resin include α-methylstyrene ABS resin replacing styrene with a-methylstyrene, ASA (Acrylonitrile-Styrene-Acrylate resin) resin replacing butadiene with acryl rubber, ACS (Chlorinated-polyethylene-Acrylonitrile-Styrene resin) resin replacing butadiene with chlorinated polyethylene, and AES (Acrylonitrile-Ethylene-Styrene resin) resin replacing butadiene with EPDM (ethylene propylene diene ternary copolymer).

The polylactic acid (PLA) resin is, for example, a polymer of a lactic acid monomer polymerized as a main component, with more than 50 mol % of lactic acid-derived structural unit. Examples of the polylactic acid resin include a polymer whose main component is poly(L-lactic acid) in which the structural unit is L-lactic acid, a polymer whose main component is poly(D-lactic acid) in which the structural unit is D-lactic acid, a polymer whose main component is poly(DL-lactic acid) in which the structural units are L-lactic acid and D-lactic acid, and a polymer whose main component is an admixture of these polymers.

The polybutylene succinate (PBS) resin includes 1,4-butanediol and succinic acid in its structural units. In addition to 1,4-butanediol and succinic acid, a copolymer of these with 3-alkoxy-1,2-propanediol can also be used. The alkoxy group of the 3-alkoxy-1,2-propanediol used for such a copolymer has preferably 1 to 10 carbon atoms, more preferably 1 to 8 carbon atoms. The PBS resin may be a plant-derived PBS resin.

Examples of the polyhydroxyalkanoate (PHA) resin include poly(3-hydroxyvalerate), poly(3-hydroxybutyrate), poly(3-hydroxypropionate), poly(4-hydroxybutyrate), poly(3-hydroxyoctanoate), and poly(3-hydroxydecanoate).

The polyhydroxybutyrate/hydroxyhexanoate (PHBH) resin is a copolymer of 3-hydroxybutyrate and 3-hydroxyhexanoate (3-hydroxybutyrate-co-3-hydroxyhexanoate polymer). The amount of 3-hydroxyhexanoate in this copolymer may be 1 to 20 mol % of all structural units.

Examples of the starch include:
raw starches (self-modified starches) such as corn starch, potato starch, sweet potato starch, wheat starch, cassava starch, sago starch, tapioca starch, sorghum starch, rice starch, bean starch, kudzu starch, bracken starch, lotus starch, and water caltrop starch;
physically modified starches such as a-starch, fractionated amylose, hygrothermally treated starch, and thermochemically modified starch;
enzymatically modified starches such as hydrolyzed dextrin, enzymatically degraded dextrin, and amylose;
acid treated starches;
oxidized starches such as hypochlorous acid oxidized starch;
chemically degraded and modified starches such as dialdehyde starch;
chemically modified starch derivatives such as esterified starch, etherified starch, cationized starch, and crosslinked starch; and
alkyl starch, hydroxyalkyl starch, and hydroxyalkylalkyl starch.

Examples of the alkyl starch include methyl starch, ethyl starch, and propyl starch. Examples of the hydroxyalkyl starch include hydroxymethyl starch, hydroxyethyl starch, and hydroxypropyl starch. Examples of the hydroxyalkylalkyl starch include hydroxymethylmethyl starch, hydroxyethylmethyl starch, and hydroxypropylmethyl starch. Examples of esterified starches as chemically modified starch derivatives include acetic acid esterified starch, succinic acid esterified starch, nitric acid esterified starch, phosphoric acid esterified starch, ureaphosphoric acid esterified starch, xanthic acid esterified starch, acetoacetic acid esterified starch, and carbamic acid esterified starch. Examples of the etherified starch include allyl etherified starch, methyl etherified starch, carboxy etherified starch, carboxymethyl etherified starch, and hydroxyethyl etherified starch. Examples of the hydroxypropyl etherified starch and cationized starch include a reaction product of starch and 2-diethylaminoethyl chloride, and a reaction product of starch and 2,3-epoxypropyltrimethylammonium chloride. Examples of the crosslinked starch include formaldehyde crosslinked starch, epichlorohydrin crosslinked starch, phosphoric acid crosslinked starch, and acrolein crosslinked starch.

Examples of the cellulose include alkyl cellulose, hydroxyalkyl cellulose, and cellulose acetate. Examples of the alkyl cellulose include methyl cellulose. The content of the methoxy group in methyl cellulose is preferably 26.0 to 33.0 mass %, more preferably 27.5 to 31.5 mass %. The content of the methoxy group in methyl cellulose can be measured according to the method of analysis relating to methyl cellulose in The Japanese Pharmacopoeia 17th Edition. Examples of the hydroxyalkyl cellulose include hydroxypropyl cellulose. The content of the hydroxypropoxy group in hydroxypropyl cellulose is preferably 53.4 to 80.5 mass %, more preferably 60.0 to 70.0 mass %. The content of the hydroxypropoxy group in hydroxypropyl cellulose can be measured according to the method of analysis relating to hydroxypropyl cellulose in The Japanese Pharmacopoeia 17th Edition.

A multilayer structure of the present invention has an oxygen transmission rate of preferably 150 cc/m²·day·atm or less, more preferably 100 cc/m²·day·atm or less. In the present invention, the oxygen transmission rate of the multilayer structure is a value determined by the method described in the EXAMPLES section.

The layers in a multilayer structure of the present invention may each contain an inorganic laminar compound to improve gas barrier properties, strength, or ease of handling. Examples of the inorganic laminar compound include mica, talc, montmorillonite, kaolinite, and vermiculite. These may be naturally occurring compounds or synthetic compounds.

The layers in a multilayer structure of the present invention may each contain a cross-linking agent to improve water resistance. Examples of the cross-linking agent include epoxy compounds, isocyanate compounds, aldehyde compounds, titanium compounds, silica compounds, aluminum compounds, zirconium compounds, and boron compounds. Preferred are silica compounds such as colloidal silica, and alkyl silicate.

The method of production of a multilayer structure of the present invention is not particularly limited. Preferably, a multilayer structure of the present invention is produced by a method that comprises the steps of obtaining a coating agent by preparing an aqueous solution containing the vinyl alcohol polymer (X) (hereinafter, also referred to with the abbreviation “PVA (X) aqueous solution”), and coating the coating agent on a surface of a substrate containing at least one resin selected from the group consisting of a polyolefin resin, a polyester resin, and a polyamide resin. When a layer such as an adhesive component layer is present between layer (C) and layer (D) as in a preferred embodiment of the present invention, a multilayer structure of the present invention may be produced by coating the coating agent on the layer (e.g., an adhesive component layer) formed on the substrate, as will be described later. In the present disclosure, the expression “coating the coating agent on a surface of a substrate” is also used to describe such a case.

The substrate may be, for example, a film made of the above resin. In certain preferred embodiments, examples of the substrate include a film made of a polyolefin resin (hereinafter, also referred to as “polyolefin film”), a film made of a polyester resin (hereinafter, also referred to as “polyester film”), and a film made of a polyamide resin (hereinafter, also referred to as “polyamide film”). In other preferred embodiments, examples of the substrate include a film made of a polyvinyl chloride (PVC) resin (hereinafter, also referred to as “polyvinyl chloride film”), a film made of an ABS resin (hereinafter, also referred to as “ABS film”), a film made of a polylactic acid (PLA) resin (hereinafter, also referred to as “polylactic acid film”), a film made of a polybutylene succinate (PBS) resin (hereinafter, also referred to as “polybutylene succinate film”), a film made of a polyhydroxyalkanoate (PHA) resin (hereinafter, also referred to as “polyhydroxyalkanoate film”), a film made of a polyhydroxybutyrate/hydroxyhexanoate (PHBH) resin (hereinafter, also referred to as “polyhydroxybutyrate/hydroxyhexanoate film”), a film made of starch (hereinafter, also referred to as “starch film”), and a film made of cellulose (hereinafter, also referred to as “cellulose film”). The substrate forms the layer (D).

The content of the PVA (X) in the PVA (X) aqueous solution is not particularly limited, and is preferably 5 to 50 mass %. A PVA (X) content falling in this range alleviates the drying stress, and exhibits more desirable coatability because of the moderate viscosity of the aqueous solution. After being coated on the substrate surface, the coating agent containing the PVA (X) aqueous solution is dried to form the layer (C). The evaporation rate in the drying process is preferably 2 to 2,000 g/m²·min, more preferably 50 to 500 g/m²·min.

The PVA (X) aqueous solution and the coating agent may contain a surfactant, a leveling agent, or the like. In view of coatability, the PVA (X) aqueous solution and the coating agent may contain a lower aliphatic alcohol such as methanol, ethanol, or isopropanol. In this case, the content of the lower aliphatic alcohol in the PVA (X) aqueous solution is preferably 100 parts or less by mass, more preferably 50 parts or less by mass, even more preferably 20 parts or less by mass relative to 100 parts by mass of water. In view of working environment, the liquid medium contained in the PVA (X) aqueous solution is solely water. The PVA (X) aqueous solution may contain a mildewcide, a preservative, or the like. The temperature of the PVA (X) aqueous solution at coating is preferably 20 to 80° C. Preferred as coating methods are gravure roll coating, reverse gravure coating, reverse roll coating, and wire bar coating. The substrate before coating with the coating agent, or the multilayer structure obtained may be subjected to stretching or heat treatment. Considering workability, this is performed preferably by a method in which the substrate, after being stretched once, is stretched again with the coating agent applied thereto, and is subjected to a heat treatment while or after the second stretching.

The heat treatment is carried out in air, for example. The heat-treatment temperature can be adjusted according to the type of substrate. In the case of a polyolefin film, the heat-treatment temperature is 140° C. to 170° C. In the case of a polyester film and a polyamide film, the heat-treatment temperature is 140° C. to 240° C. In the case of a polyvinyl chloride film, the heat-treatment temperature is 140° C. to 200° C. In the case of an ABS film, the heat-treatment temperature is 140° C. to 170° C. In the case of a polylactic acid film, the heat-treatment temperature is 140° C. to 240° C. In the case of a polybutylene succinate film, the heat-treatment temperature is 140° C. to 240° C. In the case of a polyhydroxyalkanoate film, the heat-treatment temperature is 140° C. to 240° C. In the case of a polyhydroxybutyrate/hydroxyhexanoate film, the heat-treatment temperature is 140° C. to 240° C. In the case of a starch film, the heat-treatment temperature is 140° C. to 240° C. In the case of a cellulose film, the heat-treatment temperature is 140° C. to 240° C. When the layer (C) is subjected to a heat treatment, the heat treatment is typically carried out simultaneously with the layer (D) forming the substrate.

The layer (C) has a thickness of preferably 0.1 to 20 μm, more preferably 0.1 to 9 μm (the final thickness after stretching when stretched). The multilayer structure may comprise two or more layers (C). The PVA (X) contained in two or more layers (C) may be the same or different. When the multilayer structure has two or more layers (C), the thickness of layer (C) means the thickness of a single layer (C).

The thickness ratio (C)/(D) of layer (C) to layer (D) in the multilayer structure is preferably 0.9 or less, more preferably 0.5 or less. When the multilayer structure has two or more layers (C), the thickness ratio (C)/(D) means the thickness ratio of layer (C) with respect to each layer (D).

An adhesive component layer may be formed between layer (C) and layer (D) to improve adhesive properties. Examples of the adhesive component include an anchor coating agent. The adhesive component layer can be formed by, for example, coating the substrate surface with the adhesive component before coating the coating agent.

In a multilayer structure of the present invention, a heat sealing resin layer may additionally be formed on the surface of layer (C) not contacting the layer (D). Typically, the heat sealing resin layer is formed by extrusion lamination or dry lamination. The heat sealing resin may be, for example, a polyethylene resin (such as HDPE, LDPE, or LLDPE), a polypropylene resin, an ethylene-vinyl acetate copolymer, an ethylenea-olefin random copolymer, or an ionomer resin.

### Packaging Material

A packaging material comprising a multilayer structure of the present invention represents another preferred embodiment of the present invention. By including a multilayer structure of the present invention, the packaging material exhibits excellent oxygen gas barrier properties.

The packaging material is used for packing, for example, food, drinks, chemicals (such as pesticides and pharmaceuticals), medical instruments, industrial materials (such as machinery components and delicate materials), and garments. Specifically, the packaging material is used preferably in applications requiring barrier properties against oxygen, and in applications where inside of the packaging material is displaced with various types of functional gases.

The packaging material may have a form of, for example, a vertical form-fill-seal bag, a vacuum packaging bag, a pouch with a spout, a laminated tube container, or a lid material for containers.

### Papercoating Agent

A papercoating agent of the present invention comprises a vinyl alcohol polymer (X) obtained through saponification after polymerization of a plant-derived vinyl ester monomer (A) and a petroleum-derived vinyl ester monomer (B), and has a mole ratio (A)/(B) of 5/95 to 100/0.

The substrate to be coated with a papercoating agent of the present invention is not particularly limited, and may be, for example, paper, or a substrate containing resin. A papercoating agent of the present invention may be used by itself, or may be used after adding other components.

Examples of such other components include those mentioned above as components other than the vinyl alcohol polymer (X) and water. Other examples of the additional components include:
waterproofing agents such as glyoxal, a urea resin, a melamine resin, a polyvalent metal salt, and a water-soluble polyamide resin;
pH adjusters such as ammonia, caustic soda, sodium carbonate, and phosphoric acid;
release agents;
colorants such as pigments;
unmodified PVAs and various types of modified PVAs that do not classify as vinyl alcohol polymer (X), for example, such as carboxyl-modified PVAs, sulfonic acid group-modified PVAs, acrylamide-modified PVAs, cationic group-modified PVAs, and long-chain alkyl group-modified PVAs;
water-soluble polymers such as casein, raw starches (wheat, corn, rice, potato, sweet potato, tapioca, sago), raw starch degradation products (such as dextrin), starch derivatives (such as oxidized starch, etherified starch, esterified starch, and cationized starch), seaweed polysaccharides (such as sodium alginate, carrageenan, agar (agarose, agaropectin), and furcellaran), and water-soluble cellulose derivatives (such as carboxyalkyl cellulose, alkyl cellulose, and hydroxyalkyl cellulose); and
synthetic resin emulsions such as styrene-butadiene copolymer latexes, polyacrylic acid ester emulsions, vinyl acetate-ethylene copolymer emulsions, and vinyl acetate-acrylic acid ester copolymer emulsions.

The concentration of the vinyl alcohol polymer (X) in the papercoating agent can be freely selected according to factors such as the amount of coating (an increase in the dry mass of paper as a result of coating), the type of device used for coating, and procedural conditions. The preferred concentration is 1.0 to 30 mass %, more preferably 2.0 to 25.0 mass %.

A papercoating agent according to the present invention can be coated on paper using a known method, for example, by coating on one side or both sides of paper using a device such as a size press, a gate roll coater, a sym sizer, a bar coater, or a curtain coater, or by impregnating paper with a paper coating solution (papercoating agent). Drying of the coated paper can be achieved using a known method, for example, such as a method that uses heated air, infrared rays, a heat cylinder, or a combination of these. The barrier properties of the dried coated paper can further improve with humidification or calendering. Preferably, calendering is carried out at a roll temperature ranging from ordinary temperature to 100° C., and a roll line pressure of 20 to 300 kg/cm.

Another embodiment is, for example, a coated paper coated with a papercoating agent according to the present invention. The coated paper using a papercoating agent according to the present invention can be used as a release paper base, a greaseproof paper, a gas barrier paper, a thermal paper, an inkjet paper, or a pressure-sensitive paper. The coated paper is preferably a release paper base or a greaseproof paper. That is, a certain embodiment of the coated paper is a release paper base or a greaseproof paper, for example.

The release paper base has a sealing layer (barrier layer) formed of a paper coating solution on a substrate (paper). Examples of the substrate (paper) include paperboard such as manila board, white-lined chipboard, and liners; and printing papers such as common wood-free paper, wood-containing paper, and gravure paper. The release paper has a release layer laminated on the sealing layer of the release paper base. Preferably, the release layer is constituted of a silicone resin. Examples of the silicone resin include known silicone resins, for example, such as solvent-based silicone, solventless silicone, and emulsion silicone. The amount of coating in the release paper base (an increase in the dry mass of paper as a result of coating) is not particularly limited, and is, for example, 0.1 to 5.0 g/m², preferably 0.1 to 2.5 g/m².

The greaseproof paper comprises an oilproof layer formed of a paper coating solution on a substrate (paper). Examples of the substrate (paper) include paperboard such as manila board, white-lined chipboard, and liners; printing papers such as common wood-free paper, wood-containing paper, and gravure paper; and kraft paper, glassine paper, and parchment paper. The amount of coating in the greaseproof paper (an increase in the dry mass of paper as a result of coating) is not particularly limited, and is, for example, 0.1 to 20 g/m².

A papercoating agent (paper coating solution) according to the present invention may comprise components other than PVA (X) and water, provided such additional components do not interfere with the effects of the present invention. Examples of such additional components include additives such as resins other than PVA (X), organic solvents, plasticizers, cross-linking agents, surfactants, anti-settling agents, thickeners, flow improvers, preservatives, adhesion improvers, antioxidants, penetrants, antifoaming agents, bulking agents, wetting agents, colorants, binders, water retention agents, fillers, sugars (such as starch and derivatives thereof), and latexes. These may be used alone, or two or more thereof may be used in combination. The content of the additional component in a papercoating agent according to the present invention is preferably 10 mass % or less. The preferred content may be 5 mass % or less, 2 mass % or less, 1 mass % or less, or 0.5 mass % or less.

### Seed Coating Composition

A seed coating composition of the present invention comprises a vinyl alcohol polymer (X) (hereinafter, also referred to with the abbreviation “PVA (X)”) obtained through saponification after polymerization of a plant-derived vinyl ester monomer (A) and a petroleum-derived vinyl ester monomer (B), and has a mole ratio (A)/(B) of 5/95 to 100/0.

### Pesticides

The seed coating composition may further comprise one or more hydrophobic pesticides. In the present invention, the term “pesticide” is used to broadly refer to agents such as insecticides, fungicides, nematocides, and other such materials intended to prevent or reduce damage to seeds from living organisms.

In the context of the present invention, “hydrophobic” pesticide additives refer to additives that do not dissolve in water (for example, without the use of a surfactant), or that can stably disperse in water.

Such hydrophobic pesticides are commonly known to a person skilled in the art, and are widely available in the market. Examples of commercially available products of the hydrophobic pesticides include the Accelron™ package (containing pyraclostrobin, fluxapyroxad, metalaxyl, and imidacloprid), an admixture of fungicides and insecticides.

Examples of the preferred fungicides include pyraclostrobin, fluxapyroxad, ipconazole, trifloxystrobin, metalaxyl (metalaxyl 265 ST), fludioxonil (fludioxonil 4L ST), tiabendazole (tiabendazole 4L ST), triticonazole, tefluthrin, and a combination of these.

Examples of the preferred insecticides include clothianidin, imidacloprid, SENATOR® 600 ST (Nufarm US), tefluthrin, terbufos, cypermethrin, thiodicarb, lindane, furathiocarb, acephate, and a combination of these.

The hydrophobic pesticides are typically used in small amounts (“effective amounts” to achieve the desired pesticidal effect) according to the doses recommended by manufacturers for such pesticides.

### Aqueous Coating Composition

In certain preferred embodiments, the seed coating composition is an aqueous coating composition. The aqueous coating composition comprises water as a main carrier medium.

The lower limit of the content of the PVA (X) in the coating composition is preferably 0.5 mass %, more preferably 1.0 mass %, even more preferably 2.0 mass % based on the total mass of the coating composition. The upper limit of the content of the PVA (X) in the coating composition is preferably 10 mass %, more preferably 8 mass %, even more preferably 6 mass % based on the total mass of the coating composition.

The lower limit of the solid content in an aqueous coating composition of the present invention is preferably 1 mass %, more preferably 2 mass %, even more preferably 5 mass % based on the total mass of the aqueous coating composition, depending on the optional components described below. The upper limit of the solid content in an aqueous coating composition of the present invention is preferably 25 mass %, more preferably 20 mass % based on the total mass of the aqueous coating composition.

The aqueous coating composition can be provided as a concentrate that can be diluted with water for application to seeds.

Depending on the PVA (X) and optional components, the aqueous coating composition may have a form of a solution, a dispersion, an emulsion, or a suspension, as understood by a person skilled in the art. For example, some of the components may be in a solution while the others are dispersed, emulsified, and/or suspended. In such a case, it is preferable that the components of the aqueous coating composition be essentially evenly distributed in the aqueous coating composition before application. That is, the aqueous coating composition is preferably a stable solution, emulsion, and/or dispersion, or a solution, emulsion, dispersion, and/or suspension in which the components can be evenly distributed with ease by a conventional means such as stirring involving or not involving gentle heating.

### Optional Components

A seed coating composition according to the present invention may comprise optional components, in addition to the PVA (X). Examples of such optional components include polymers other than PVA (X), plasticizers, talc, waxes, pigments, and detackifiers. These may be used alone, or two or more thereof may be used in combination. For example, a polymer other than PVA (X) may be blended into PVA (X) to improve the coating properties. Examples of polymers other than PVA (X) include polyvinylpyrrolidone, starch, and high-molecular polyethylene glycol. Plasticizers, talc, waxes, pigments, or detackifiers may be optionally be added to the seed coating solution, emulsion, or suspension.

### Application of Aqueous Coating Composition

Methods of application of the aqueous coating composition to seeds are known to a person skilled in the art. Conventional methods include, for example, mixing, spraying, or a combination of these. Various types of applicators that make use of a variety of coating techniques are commercially available, for example, such as spin coaters, drum coaters, and fluidized beds. Seeds may be coated through a batch or continuous coating process.

Preferably, seeds are substantially uniformly coated with a film of the coating composition.

### Coated Seeds

Examples of seeds that can be treated with a seed coating composition according to the present invention include wheat, barley, rye, sorghum, apple, peach, peach, cherry, strawberry, blackberry, sugar beet, beet, lentil, pea, soybean, mustard, olive, sunflower, coconut oil plant, cocoa bean, magro, cumber, melon, flax, hemp, orange, lemon, grapefruit, mandarin, lettuce, asparagus, cabbage, carrot, onion, tomato, paprika, avocado, flower, broadleaf tree, soybean, tomato, corn, potato, onion, flower bulbs, rice, sorghum, tobacco, nut, coffee, and sugarcane.

### Aqueous Emulsion

An aqueous emulsion of the present invention comprises a dispersant and a dispersoid, wherein the dispersoid comprises a polymer (Y1) containing an ethylenically unsaturated monomer unit, and the dispersant comprises a vinyl alcohol polymer (X) obtained through saponification after polymerization of a plant-derived vinyl ester monomer (A) and a petroleum-derived vinyl ester monomer (B), and has a mole ratio (A)/(B) of 5/95 to 100/0.

An aqueous emulsion of the present invention is an aqueous emulsion that comprises the PVA (X) as a dispersant, and the ethylenically unsaturated monomer unit-containing polymer (Y1) as a dispersoid. The proportions of the PVA (X) and the ethylenically unsaturated monomer unit-containing polymer (Y1) are not particularly limited. However, the mass ratio (X)/(Y1) is preferably 2/98 to 20/80, more preferably 5/95 to 15/85 in terms of solids. With the mass ratio confined in these ranges, the aqueous emulsion obtained can exhibit more desirable viscosity stability, and the water resistance of the coating obtained tends to be desirable.

The content of solids in an aqueous emulsion of the present invention is not particularly limited, and is preferably 30 mass % or more and 60 mass % or less, more preferably 35 mass % or more and 55 mass % or less.

### Ethylenically Unsaturated Monomer Unit

Examples of the ethylenically unsaturated monomer as material of the ethylenically unsaturated monomer unit-containing polymer (Y1) include:
olefinic monomers such as ethylene, propylene, and isobutylene;
halogenated olefinic monomers such as vinyl chloride, vinyl fluoride, vinylidene chloride, and vinylidene fluoride;
vinyl ester monomers such as vinyl formate, vinyl acetate, vinyl propionate, and vinyl versatate;
(meth)acrylic acid ester monomers such as (meth)acrylic acid, methyl (meth)acrylate, ethyl (meth)acrylate, butyl (meth)acrylate, 2-ethylhexyl (meth)acrylate, dodecyl (meth)acrylate, and 2-hydroxyethyl (meth)acrylate;
(meth)acrylamide monomers such as dimethylaminoethyl (meth)acrylate and products of quaternization thereof, (meth)acrylamide, N-methylol(meth)acrylamide, N,N-dimethyl(meth)acrylamide, (meth)acrylamide-2-methylpropanesulfonic acid and sodium salts thereof;
styrene monomers such as styrene, a-methylstyrene, p-styrenesulfonic acid, and sodium salts and potassium salts thereof;
diene monomers such as butadiene, isoprene, and chloroprene; and
N-vinylpyrrolidone.
These may be used alone, or two or more thereof may be used in combination.

The polymer (Y1) containing an ethylenically unsaturated monomer unit is preferably a polymer having a specific unit derived from at least one selected from the group consisting of a vinyl ester monomer, a (meth)acrylic acid ester monomer, a styrene monomer, and a diene monomer. The content of the specific unit is preferably 70 mass % or more, more preferably 75 mass % or more, even more preferably 80 mass % or more, particularly preferably 90 mass % or more with respect to all monomer units of the polymer. The emulsion polymerization stability of the aqueous emulsion tends to be insufficient when the content of the specific unit is less than 70 mass %.

Particularly preferred as the specific unit is a vinyl ester monomer, most preferably vinyl acetate. That is, the content of the vinyl ester monomer unit is preferably 70 mass % or more with respect to all monomer units of the polymer. More preferably, the content of the monomer unit derived from vinyl acetate is 70 mass % or more. Even more preferably, the content of the monomer unit derived from vinyl acetate is 90 mass % or more.

### Method of Production of Aqueous Emulsion

An example of a method of production an aqueous emulsion of the present invention is a method that polymerizes the ethylenically unsaturated monomer by emulsion polymerization with a polymerization initiator in the presence of PVA (X). An aqueous emulsion produced by such a method generates no aggregates in particular, and excels in water resistance.

The dispersion medium of emulsion polymerization is preferably an aqueous medium containing water as a main component. The aqueous medium containing water as a main component may contain a water-soluble organic solvent (e.g., alcohols, ketones) that can dissolve in water in any proportions. Here, “aqueous medium containing water as a main component” refers to a dispersion medium containing 50 mass % or more of water. In view of cost and environmental burden, the dispersion medium is preferably an aqueous medium containing 90 mass % or more of water, more preferably water.

When the method feeds PVA (X) into the polymerization system as a dispersion stabilizer for emulsion polymerization, PVA (X) can be fed or added using any methods. For example, the dispersion stabilizer for emulsion polymerization may be added early at once to the polymerization system, or may be continuously added during emulsion polymerization. In view of increasing the graft rate of PVA (X) to the ethylenically unsaturated monomer, it is preferable that the dispersion stabilizer for emulsion polymerization be added early at once to the polymerization system. In this case, it is preferable to add PVA (X) to cold water or pre-heated hot water, and heat and stir the PVA (X) at 80 to 90° C. to uniformly disperse the PVA (X).

The content of PVA (X) as a dispersion stabilizer for emulsion polymerization in emulsion polymerization is not particularly limited, and is preferably 0.2 parts or more by mass and 40 parts or less by mass, more preferably 0.3 parts or more by mass and 20 parts or less by mass, even more preferably 0.5 parts or more by mass and 15 parts or less by mass relative to 100 parts by mass of the ethylenically unsaturated monomer. When the amount of PVA (X) added is less than 0.2 parts by mass, the aqueous emulsion tends to generate aggregates of dispersoid particles, or the polymerization stability tends to decrease. When the amount of PVA (X) added is more than 40 parts by mass, emulsion polymerization may fail to proceed in a uniform fashion as a result of excess viscosity in the polymerization system, or removal of the heat of polymerization tends to be insufficient.

The polymerization initiator used in the emulsion polymerization may be a water-soluble single initiator or water-soluble redox initiator commonly used for emulsion polymerization. Such initiators may be used alone, or two or more thereof may be used in combination. Preferred are redox initiators.

Examples of the water-soluble single initiator include azo initiators, and peroxides such as hydrogen peroxide and persulfates (such as potassium persulfate, sodium persulfate, and ammonium persulfate). Examples of the azo initiators include 2,2′-azobis(isobutyronitrile), 2,2′-azobis(2,4-dimethylvaleronitrile), and 2,2′-azobis(4-methoxy-2,4-dimethylvaleronitrile).

The redox initiator may be an initiator combining an oxidant and a reductant.

The oxidant is preferably a peroxide. Examples of the reductant include metal ions and reducing compounds. Examples of the combination of an oxidant and a reductant include: a combination of a peroxide and a metal ion; a combination of a peroxide and a reducing compound; and a combination of a peroxide, a metal ion, and a reducing compound. Examples of the peroxide include hydrogen peroxide; hydroxyperoxides such as cumene hydroperoxide and t-butyl hydroperoxide; persulfates (potassium persulfate, sodium persulfate, ammonium persulfate); t-butyl peroxyacetate; and peresters (t-butyl peroxybenzoate). Examples of the metal ion include metal ions capable of undergoing a single-electron transfer, for example, such as Fe²⁺, Cr²⁺, V²⁺, Co²⁺, Ti³⁺, and Cu⁺. Examples of the reducing compound include sodium hydrogen sulfite, sodium hydrogen carbonate, tartaric acid, fructose, dextrose, sorbose, inositol, rongalite, and ascorbic acid. Preferred among these is a combination of at least one oxidant selected from the group consisting of hydrogen peroxide, potassium persulfate, sodium persulfate, and ammonium persulfate, and at least one reductant selected from the group consisting of sodium hydrogen sulfite, sodium hydrogen carbonate, tartaric acid, rongalite, and ascorbic acid. More preferred is a combination of hydrogen peroxide and at least one reductant selected from the group consisting of sodium hydrogen sulfite, sodium hydrogen carbonate, tartaric acid, rongalite, and ascorbic acid.

For emulsion polymerization, it is also possible to appropriately use, for example, an alkali metal compound, a surfactant, a buffering agent, a polymerization degree adjuster, a plasticizer, or a coalescing agent, provided that it does not hinder the effects of the present invention.

The alkali metal compound is not particularly limited, as long as it contains an alkali metal (sodium, potassium, rubidium, cesium). The alkali metal compound may be an alkali metal ion itself, or a compound containing an alkali metal.

The content of the alkali metal compound (in terms of an alkali metal) can be appropriately selected according to the type of the alkali metal compound used. Preferably, the content of the alkali metal compound (in terms of an alkali metal) is preferably 100 to 15,000 ppm, more preferably 120 to 12,000 ppm, even more preferably 150 to 8,000 ppm relative to the total mass of the aqueous emulsion (in terms of solids). The stability of emulsion polymerization tends to decrease when the content of alkali metal compound is less than 100 ppm, whereas a color tends to develop in the coating obtained when the content of alkali metal compound is more than 15,000 ppm. The content of alkali metal compound can be measured with an ICP emission spectrometer. In the present specification, “ppm” means ppm by mass.

Specific examples of compounds containing alkali metals include weakly basic alkali metal salts (for example, alkali metal carbonates, alkali metal acetates, alkali metal bicarbonates, alkali metal phosphates, alkali metal sulfates, alkali metal halides, alkali metal nitrates), and strongly basic alkali metal compounds (for example, hydroxides of alkali metals, and alkoxides of alkali metals). These alkali metal compounds may be used alone, or two or more thereof may be used in combination.

Examples of the weakly basic alkali metal salts include alkali metal carbonates (for example, sodium carbonate, potassium carbonate, rubidium carbonate, cesium carbonate), alkali metal bicarbonates (for example, sodium bicarbonate, potassium bicarbonate), alkali metal phosphates (for example, sodium phosphate, potassium phosphate), alkali metal carboxylates (for example, sodium acetate, potassium acetate, cesium acetate), alkali metal sulfates (for example, sodium sulfate, potassium sulfate, cesium sulfate), alkali metal halides (for example, cesium chloride, cesium iodide, potassium chloride, sodium chloride), and alkali metal nitrates (for example, sodium nitrate, potassium nitrate, cesium nitrate). In view of imparting basicity to the emulsion, preferred for use are alkali metal carboxylates, alkali metal carbonates, and alkali metal bicarbonates, which can act as weakly acidic and strongly basic salts when dissociated. More preferred are alkali metal carboxylates.

By using weakly basic alkali metal salts such as above, these alkali metal salts act as a pH buffer in emulsion polymerization, and allow the emulsion polymerization to stably proceed.

The surfactant may be any of a non-ionic surfactant, an anionic surfactant, and a cationic surfactant. The non-ionic surfactant is not particularly limited, and examples include polyoxyethylene alkyl ethers, polyoxyethylene alkyl phenyl ethers, polyoxyethylene fatty acid esters, polyoxyalkylene alkyl ethers, polyoxyethylene derivatives, sorbitan fatty acid esters, polyoxyethylene sorbitan fatty acid esters, polyoxyethylene sorbitol fatty acid esters, and glycerin fatty acid esters. The anionic surfactant is not particularly limited, and examples include alkyl sulfates, alkylaryl sulfates, alkyl sulfonates, sulfates of hydroxy alkanols, sulfosuccinic acid esters, and sulfates and phosphates of alkyl or alkylaryl polyethoxy alkanols. The cationic surfactant is not particularly limited, and examples include alkylamine salts, quaternary ammonium salts, and polyoxyethylene alkylamines. In view of water resistance, hot water resistance, and boiling resistance, the amount of the surfactant used is preferably 2 mass % or less with respect to the total amount of the ethylenically unsaturated monomer (for example, vinyl acetate).

Examples of the buffering agent include acids such as acetic acid, hydrochloric acid, and sulfuric acid; bases such as ammonia, amine, caustic soda, caustic potash, and calcium hydroxide; and alkali carbonates, phosphates, and acetates. Examples of the polymerization degree adjuster include mercaptans and alcohols.

Conventionally known plasticizers or coalescing agents, such as those listed below, may be added to an aqueous emulsion of the present invention. Examples of the plasticizers or coalescing agents include dimethyl phthalate, diethyl phthalate, diamyl phthalate, dibutyl phthalate, acetyl tributyl citrate, diisobutyl adipate, dibutyl sebacate, dimethyl glycol adipate, dimethyl glycol sebacate, diethyl glycol sebacate, dimethyl glycol phthalate, diethyl glycol phthalate, dibutyl glycol phthalate, tricresyl phosphate, dioctyl phthalate, texanol, polyethylene glycol monophenyl ether, polypropylene glycol monophenyl ether, benzyl alcohol, butyl carbitol acetate, butyl carbitol, 3-methyl-3-methoxybutanol, ethylene glycol, acetylene glycol butyl cellosolve, ethylene cellosolve, butyl cellosolve, biphenyl chloride, propylene glycol-mono-2-ethylhexanoate, diethylene glycol monobutyl ether, and dipropylene glycol monobutyl ether. When added, the plasticizer or coalescing agent is added in an amount of preferably 1 to 200 parts by mass, more preferably 2 to 50 parts by mass relative to 100 parts by mass of the polymer containing an ethylenically unsaturated monomer.

Conventionally known bulking agents, fillers, or pigments, such as those listed below, may be added to an aqueous emulsion of the present invention after emulsion polymerization. Examples of the bulking agents, fillers, or pigments include calcium carbonate, kaolin clay, pagodite clay, talc, titanium oxide, iron oxide, pulp, various resin powders, mica, sericite, bentonite, asbestos, calcium silicate, aluminum silicate, diatomaceous earth, silica stone, silicic anhydride, silicic acid hydrate, magnesium carbonate, aluminum hydroxide, barium sulfate, calcium sulfate, and carbon black. When added, the bulking agent, filler, or pigment is added in an amount of preferably 1 to 200 parts by mass, more preferably 20 to 150 parts by mass relative to 100 parts by mass of the polymer (Y1) containing an ethylenically unsaturated monomer.

The aqueous emulsions of the present invention obtained by the foregoing methods can be used in applications such as paints and fiberworking, preferably adhesives, in addition to bonding applications such as woodworking and paper processing. The aqueous emulsion may be used as it is, or may optionally be prepared into an emulsion composition with a variety of conventionally known emulsions or ordinary additives, provided that it does not hinder the effects of the present invention. Examples of such additives include organic solvents (for example, aromatic compounds such as toluene and xylene, alcohols, ketones, esters, and halogen-containing solvents), cross-linking agents, surfactants, plasticizers, anti-settling agents, thickeners, flow improvers, preservatives, antifoaming agents, bulking agents, wetting agents, colorants, binders, and water retention agents. These may be used alone, or two or more thereof may be used in combination. Examples of the cross-linking agents include polyisocyanate compounds, hydrazine compounds, polyamidepolyamine epichlorohydrin resin (PAE), water-soluble aluminum salts (such as aluminum chloride, and aluminum nitrate), and glyoxal resins such as urea-glyoxal resin. The polyisocyanate compounds are compounds having two or more isocyanate groups within the molecule. Examples of the polyisocyanate compounds include tolylene diisocyanate (TDI), hydrogenated TDI, trimethylolpropane-TDI adduct (for example, Desmodur L from Bayer), triphenylmethane triisocyanate, methylene bisphenyl isocyanate (MDI), polymethylene polyphenyl polyisocyanate (PMDI), hydrogenated MDI, polymerized MDI, hexamethylene diisocyanate (HDI), xylylene diisocyanate (XDI), 4,4-dicyclohexyl methane diisocyanate, and isophorone diisocyanate (IPDI). The polyisocyanate compound may be a prepolymer having an isocyanate group in a terminal group after previous polymerization of a polyol with excess polyisocyanate. The cross-linking agents may be used alone, or two or more thereof may be used in combination. The content of the cross-linking agent is preferably 1 to 50 parts by mass relative to 100 parts by mass of the polymer (Y1). With 1 part or more by mass of cross-linking agent, the emulsion composition can exhibit even superior water resistance and heat resistance. With 50 parts or less by mass of cross-linking agent, it is possible to more easily form a desirable coating, and provide even superior water resistance and heat resistance.

The adherend of the adhesive agent obtained by the foregoing method may be, for example, paper, wood, or plastic. Among these materials, the adhesive agent is particularly suited for wood, making it usable in applications such as bonded wood, plywood, coated plywood, and fiberboard.

An aqueous emulsion of the present invention can also be used in a wide range of applications, including, for example, inorganic binders, cement chemical admixtures, and mortar primers. It is also possible to effectively use an aqueous emulsion of the present invention as a powder, or a powder emulsion as it is also called, after preparing a powder from the aqueous emulsion using a technique such as spray drying.

### Dispersion Stabilizer for Suspension Polymerization

A dispersion stabilizer for suspension polymerization of vinyl compounds of the present invention comprises a vinyl alcohol polymer (X) obtained through saponification after polymerization of a plant-derived vinyl ester monomer (A) and a petroleum-derived vinyl ester monomer (B), and has a mole ratio (A)/(B) of 5/95 to 100/0.

A preferred use of a PVA (X) of the present invention is a dispersion stabilizer for polymerization of a vinyl compound used as a monomer (hereinafter, also referred to as “vinyl monomer”), and a PVA (X) of the present invention can preferably be used for suspension polymerization of vinyl monomers. A certain preferred embodiment of the present invention is, for example, a vinyl resin production method that comprises the step of polymerizing a vinyl compound by suspension polymerization in the presence of the dispersion stabilizer for suspension polymerization.

Examples of the vinyl monomer include:
vinyl halides such as vinyl chloride;
vinyl ester monomers such as vinyl acetate and vinyl propionate;
(meth)acrylic acid and esters and salts thereof;
maleic acid, fumaric acid, and esters and anhydrides thereof; and
styrene, acrylonitrile, vinylidene chloride, and vinyl ethers.
Preferably, vinyl chloride is polymerized by suspension polymerization either alone or with a monomer capable of copolymerizing with vinyl chloride. Examples of the monomer capable of copolymerizing with vinyl chloride include:
vinyl ester monomers such as vinyl acetate and vinyl propionate;
(meth)acrylic acid esters such as methyl (meth)acrylate and ethyl (meth)acrylate;
α-olefins such as ethylene and propylene;
unsaturated dicarboxylic acids such as maleic anhydride and itaconic acid; and
acrylonitrile, styrene, vinylidene chloride, and vinyl ethers.

An aqueous medium is preferred as the medium used for the suspension polymerization. Examples of the aqueous medium include water, and a medium containing water and an organic solvent. The aqueous medium contains preferably 90 mass % or more of water.

The dispersant used for the suspension polymerization can be used in any amount, typically 1 part or less by mass, preferably 0.01 to 0.5 parts by mass with respect to 100 parts by mass of the vinyl compound.

Typically, the mass ratio of the aqueous medium and the vinyl compound in the suspension polymerization of the vinyl compound is preferably 0.9 to 1.2 (aqueous medium/vinyl compound).

Oil-soluble or water-soluble polymerization initiators conventionally used for polymerization of vinyl chloride monomer or the like can be used for the suspension polymerization of vinyl monomers. Examples of the oil-soluble polymerization initiators include:
peroxydicarbonate compounds such as diisopropyl peroxydicarbonate, di(2-ethylhexyl)peroxydicarbonate, and diethoxyethyl peroxydicarbonate;
perester compounds such as t-butylperoxyneodecanoate, t-butylperoxypivalate, t-hexylperoxypivalate, and a-cumylperoxyneodecanoate;
peroxides such as acetylcyclohexyl sulfonyl peroxide, 2,4,4-trimethylpentyl-2-peroxyphenoxyacetate, 3,5,5-trimethyl hexanoyl peroxide, and lauroyl peroxide; and
azo compounds such as azobis-2,4-dimethylvaleronitrile, and azobis(4-2,4-dimethylvaleronitrile).

Examples of the water-soluble polymerization initiators include potassium persulfate, ammonium persulfate, hydrogen peroxide, and cumene hydroperoxide. These oil-soluble or water-soluble polymerization initiators may be used alone, or two or more thereof may be used in combination.

Various additives may optionally be added to the polymerization reaction system in the suspension polymerization of vinyl monomers. Examples of such additives include polymerization degree adjusters such as aldehydes, halogenated hydrocarbons, and mercaptans, and polymerization inhibitors such as phenol compounds, sulfur compounds, and N-oxide compounds. It is also possible to optionally add an additive such as a pH adjuster or a cross-linking agent.

The polymerization temperature in the suspension polymerization of vinyl monomers is not particularly limited, and can be adjusted to a temperature as low as about 20° C., or a temperature higher than 90° C. In one of preferred embodiments, a polymerizer equipped with a reflux condenser may be used to improve the heat removal efficiency of the polymerization reaction system.

Additives commonly used for suspension polymerization, such as preservatives, mildewcides, antiblocking agents, and antifoaming agents, may optionally be added to the dispersion stabilizer. The content of such an additive is typically 1.0 mass % or less. The additive may be used alone, or two or more thereof may be used in combination.

When a PVA (X) of the present invention is used as a dispersion stabilizer for suspension polymerization, the dispersion stabilizer may be used by itself, or may be used with other components such as water-soluble emulsifiers. Examples of the water-soluble emulsifiers include:
water-soluble cellulose ethers such as methyl cellulose, hydroxyethyl cellulose, hydroxypropyl cellulose, and hydroxypropyl methyl cellulose;
water-soluble polymers such as polyvinyl alcohol, and gelatin;
oil-soluble emulsifiers such as sorbitan monolaurate, sorbitan trioleate, glycerin tristearate, and an ethylene oxide-propylene oxide block copolymer; and
polyoxyethylene sorbitan monolaurate, polyoxyethylene glycerin oleate, and sodium laurate.
These may be used alone, or two or more thereof may be used in combination.

When a PVA (X) of the present invention is used as a dispersion stabilizer for suspension polymerization, a water-soluble or water-dispersive auxiliary dispersion stabilizer may be used in combination. The auxiliary dispersion stabilizer may be a vinyl alcohol polymer (Y2) (hereinafter, also referred to with the abbreviation “PVA (Y2)”). The PVA (Y2) used as an auxiliary dispersion stabilizer may be, for example, a partially saponified PVA having a degree of saponification of less than 65 mol %. The partially saponified PVA has an degree of saponification of preferably 20 mol % or more and less than 60 mol %, more preferably 25 mol % or more and 58 mol % or less, even more preferably 30 mol % or more and 56 mol % or less. The PVA (Y2) has a degree of polymerization of preferably 50 or more and 750 or less, more preferably 100 or more and 700 or less, even more preferably 120 or more and 650 or less, particularly preferably 150 or more and 600 or less. The degree of saponification and degree of polymerization of PVA (Y2) can be measured using the same methods used for PVA (X). A certain preferred embodiment is, for example, an auxiliary dispersion stabilizer in which the PVA (Y2) is a partially saponified PVA having a degree of saponification of less than 65 mol %, and a degree of polymerization of 50 or more and 750 or less. Another preferred embodiment is, for example, an auxiliary dispersion stabilizer in which the PVA (Y2) is a partially saponified PVA having a degree of saponification of 30 mol % or more and less than 60 mol %, and a degree of polymerization of 180 or more and 650 or less. The PVA (Y2) used as an auxiliary dispersion stabilizer may be a vinyl alcohol polymer obtained through saponification after polymerization of an ordinary petroleum-derived vinyl ester monomer, or may be a vinyl alcohol polymer obtained through saponification after polymerization of the plant-derived vinyl ester monomer (A) and the petroleum-derived vinyl ester monomer (B). The auxiliary dispersion stabilizer may be one that has acquired self-emulsification capability after the introduction of an ionic group such as carboxylic acid or sulfonic acid.

The mass ratio of the dispersion stabilizer and the auxiliary dispersion stabilizer (dispersion stabilizer/auxiliary dispersion stabilizer) of when the auxiliary dispersion stabilizer is used with the dispersion stabilizer cannot be specified definitively because it depends on factors such as the type of the dispersion stabilizer used. However, the mass ratio ranges preferably from 95/5 to 20/80, more preferably 90/10 to 30/70. The dispersion stabilizer and the auxiliary dispersion stabilizer may be fed at once early in polymerization, or may be fed in divided portions during polymerization.

### Auxiliary Dispersion Stabilizer for Suspension Polymerization

A vinyl alcohol polymer (PVA) used in the present invention comprises a vinyl alcohol polymer (X) obtained through saponification after polymerization of a plant-derived vinyl ester monomer (A) and a petroleum-derived vinyl ester monomer (B), and has a mole ratio (A)/(B) of 5/95 to 100/0.

A certain preferred use of a PVA (X) of the present invention is an auxiliary dispersion stabilizer for polymerization of vinyl compounds, and a PVA (X) of the present invention can preferably be used for suspension polymerization of vinyl monomers. Examples of the vinyl monomers include those described in conjunction with the dispersion stabilizer for suspension polymerization.

An aqueous medium is preferred as the medium used for the suspension polymerization. Examples of the aqueous medium include water, and a medium containing water and an organic solvent. The aqueous medium contains preferably 90 mass % or more of water.

Oil-soluble or water-soluble polymerization initiators conventionally used for polymerization of vinyl chloride monomers or the like can be used for the suspension polymerization of vinyl monomers. Examples of the oil-soluble or water-soluble polymerization initiators include those described in conjunction with the dispersion stabilizer for suspension polymerization.

Various additives may optionally be added to the polymerization reaction system in the suspension polymerization of vinyl monomers. Examples of such additives include polymerization degree adjusters such as aldehydes, halogenated hydrocarbons, and mercaptans, and polymerization inhibitors such as phenol compounds, sulfur compounds, and N-oxide compounds. It is also possible to optionally add an additive such as a pH adjuster or a cross-linking agent.

The polymerization temperature in the suspension polymerization of vinyl monomers is not particularly limited, and can be adjusted to a temperature as low as about 20° C., or a temperature higher than 90° C. In one of preferred embodiments, a polymerizer equipped with a reflux condenser may be used to improve the heat removal efficiency of the polymerization reaction system.

Additives commonly used for suspension polymerization, such as preservatives, mildewcides, antiblocking agents, and antifoaming agents, may optionally be added to the auxiliary dispersion stabilizer. The content of such an additive is typically 1.0 mass % or less. The additive may be used alone, or two or more thereof may be used in combination.

An auxiliary dispersion stabilizer of the present invention can be used with a dispersion stabilizer for suspension polymerization. Another preferred embodiment of the present invention is, for example, a vinyl resin production method that comprises the step of polymerizing a vinyl compound by suspension polymerization in the presence of the auxiliary dispersion stabilizer and a dispersion stabilizer for suspension polymerization, and in which the dispersion stabilizer for suspension polymerization comprises a vinyl alcohol polymer (Y3) (hereinafter, also referred to with the abbreviation “PVA (Y3)”) having a degree of saponification of 65 mol % or more, and a viscosity-average degree of polymerization of 600 or more.

When a PVA (X) of the present invention is used as an auxiliary dispersion stabilizer for suspension polymerization, the auxiliary dispersion stabilizer may be used with the dispersion stabilizer comprising a PVA (Y3). The PVA (Y3) may be a vinyl alcohol polymer obtained through saponification after polymerization of an ordinary petroleum-derived vinyl ester monomer, or may be a vinyl alcohol polymer (Y3-1) obtained through saponification after polymerization of the plant-derived vinyl ester monomer (A) and the petroleum-derived vinyl ester monomer (B).

The PVA (Y3) has a viscosity-average degree of polymerization of preferably 150 or more and 5,000 or less, more preferably 300 or more and 4,000 or less, even more preferably 600 to 3,500. The PVA (Y3) has a degree of saponification of preferably 60 mol % to 99.5 mol %, more preferably 65 mol % to 99.2 mol %, even more preferably 68 mol % to 99.0 mol %. The degree of saponification and degree of polymerization of PVA (Y3) can be measured using the same methods used for PVA (X). The PVA (Y3) can be produced using a conventionally known method. The method of production of vinyl alcohol polymer (Y3-1) is the same as that of PVA (X). The foregoing desired ranges can be set by appropriately setting the polymerization and saponification conditions. In a certain preferred embodiment, the PVA (Y3) has a degree of saponification of 65 mol % or more, and a viscosity-average degree of polymerization of 600 or more. In another certain preferred embodiment, the viscosity-average degree of polymerization is 500 or more and 5,000 or less, and the degree of saponification is 65 mol % or more and 99 mol % or less.

The mass ratio of the dispersion stabilizer and the auxiliary dispersion stabilizer (dispersion stabilizer/auxiliary dispersion stabilizer) of when the auxiliary dispersion stabilizer is used with the dispersion stabilizer cannot be specified definitively because it depends on factors such as the type of the dispersion stabilizer used. However, the mass ratio ranges preferably from 95/5 to 20/80, more preferably 90/10 to 30/70. The dispersion stabilizer and the auxiliary dispersion stabilizer may be fed at once early in polymerization, or may be fed in divided portions during polymerization.

The auxiliary dispersion stabilizer for suspension polymerization may be used with a water-soluble emulsifier commonly used for suspension polymerization of vinyl compounds in an aqueous medium. Examples of such a water-soluble emulsifier include:
water-soluble cellulose ethers such as methyl cellulose, hydroxyethyl cellulose, hydroxypropyl cellulose, and hydroxypropyl methyl cellulose;
water-soluble polymers such as gelatin;
oil-soluble emulsifiers such as sorbitan monolaurate, sorbitan trioleate, glycerin tristearate, and an ethylene oxide-propylene oxide block copolymer; and
polyoxyethylene sorbitan monolaurate, polyoxyethylene glycerin oleate, and sodium laurate.

The water-soluble emulsifier may be added in any amounts, preferably 0.01 parts or more by mass and 1.0 part or less by mass per 100 parts by mass of the vinyl compound.

For suspension polymerization of vinyl compounds, the auxiliary dispersion stabilizer for suspension polymerization may be fed into a polymerization vessel using any method. The auxiliary dispersion stabilizer for suspension polymerization may be fed by preparing an aqueous solution of the auxiliary dispersion stabilizer, or a mixed solution of the auxiliary dispersion stabilizer in water with methanol or ethanol. Alternatively, the auxiliary dispersion stabilizer for suspension polymerization may be fed by mixing an aqueous solution containing the auxiliary dispersion stabilizer for suspension polymerization and the dispersion stabilizer for suspension polymerization. It is also possible to separately feed an aqueous solution of the auxiliary dispersion stabilizer for suspension polymerization and an aqueous solution of the dispersion stabilizer for suspension polymerization.

For suspension polymerization of vinyl compounds, the auxiliary dispersion stabilizer for suspension polymerization may be fed into a polymerization vessel in any amounts. Preferably, an aqueous solution of the auxiliary dispersion stabilizer for suspension polymerization is fed in such a way that the PVA (X) is 30 ppm or more and 1,000 ppm or less, more preferably 50 ppm or more and 800 ppm or less, even more preferably 100 ppm or more and 500 ppm or less relative to the vinyl compound (e.g., a vinyl chloride monomer).

By suspension polymerization of a vinyl compound using the foregoing method in the presence of the auxiliary dispersion stabilizer for suspension polymerization, vinyl polymer particles can be obtained that have high plasticizer absorbability with no foreign materials such as fisheyes, and that involve reduced formation of coarse particles, and enable easy removal of remaining monomer components. The vinyl polymer particles can be used for a variety of molded product applications after adding a plasticizer or the like as appropriate.

### EXAMPLES

The following describes the present invention in greater detail by way of Examples. It should be noted, however, that the present invention is not limited by the following Examples. In the following, “part(s)” and “%” are by mass, unless otherwise specifically stated.

### Ethylene Unit Content of Ethylene-Modified PVA

The ethylene unit content of ethylene-modified PVA was determined by 1H-NMR measurement of an ethylene-modified vinyl ester polymer, a precursor or a re-acetified product of ethylene-modified PVA. Specifically, specimens of the ethylene-modified vinyl ester polymers of Synthesis Examples 7-3 and 7-5 were each purified by reprecipitation at least three times with a mixed solution of n-hexane and acetone, and dried at 80° C. for 3 days under reduced pressure to prepare an ethylene-modified vinyl ester polymer for analysis. The ethylene-modified vinyl ester polymer so prepared for analysis was dissolved in DMSO-d₆, and a ¹H-NMR measurement (500 MHz) was conducted at 80° C. The ethylene unit content was calculated from a peak (integration value P: 4.7 to 5.2 ppm) derived from the methine proton on the backbone of vinyl acetate, and peaks (integration value Q: 1.0 to 1.6 ppm) derived from the methylene protons on the backbones of ethylene and vinyl acetate, using the following formula.

Ethylene unit content (mol %)=100×((Q−2P)/4)/P

### Viscosity-Average Degree of Polymerization of PVA

The viscosity-average degree of PVA was measured according to JIS K 6726:1994. Specifically, the PVA or ethylene-modified PVA was saponified to a degree of saponification of 99.5 mol % or more when the PVA or ethylene-modified PVA had a degree of saponification of less then 99.5 mol %, and the viscosity-average degree of polymerization was determined using the following formula with a limiting viscosity [η] (dL/g) measured in water at 30° C.

Viscosity-average degree of polymerization=([η]×1000/8.29)^{(1/0.62)}

### Degree of Saponification of PVA

The degree of saponification of PVA was determined according to JIS K 6726:1994.

### Synthesis Example 1-1

A spherical silica support was impregnated with an aqueous solution containing an aqueous solution of sodium tetrachloropalladate and an aqueous solution of hydrogen tetrachloroaurate tetrahydrate, in an amount equivalent of the amount of water absorbable by the support. The support was then immersed and left to stand in an aqueous solution containing sodium metasilicate nonahydrate. After adding an aqueous solution of hydrazine hydrate, the mixture was left to stand at room temperature, and washed with water until there was no chloride ion in water, followed by drying. The palladium/gold/support composition was immersed and left to stand in an aqueous solution of acetic acid. After being washed with water and dried, the composition was impregnated with an aqueous solution of potassium acetate in an amount equivalent of the amount of water absorbable by the support. This was followed by drying to obtain a vinyl acetate synthesizing catalyst.

The catalyst obtained was diluted with glass beads, and filled into a SUS reaction tube, followed by flowing a mixed gas of ethylene, oxygen, water, acetic acid, and nitrogen to allow reaction. For ethylene, sugarcane-derived bio-ethylene (manufactured by Braskem S.A.) was used. The acetic acid was introduced into the reaction system in vapor form after vaporization. The yield and selectivity of vinyl acetate were found by analyzing the gas emerging from the reaction. The ¹⁴C/C ratio was found to be 5.0×10⁻¹³ after analyzing the vinyl acetate using the method described above.

### Synthesis Example 1-2

A uniform mixture of 50 parts of the plant-derived vinyl acetate of Synthesis Example 1-1 and 50 parts of ordinary petroleum-derived vinyl acetate was used as raw material to synthesize a PVA, as follows.

A 250-L reaction vessel equipped with a stirrer, a nitrogen inlet, an ethylene inlet, an initiator feed port, and a delay solution feed port was charged with 127.5 kg of the vinyl acetate and 22.5 kg of methanol, and, after raising the temperature to 60° C., the mixture was purged with nitrogen by bubbling nitrogen for 30 minutes. Thereafter, ethylene was introduced so as to bring the pressure inside the reaction vessel to 3.4 kg/cm². Separately, a 2.8 g/L reaction initiator solution was prepared by dissolving initiator 2,2′-azobis(4-methoxy-2,4-dimethylvaleronitrile) (AMV) in methanol, and purged with nitrogen by bubbling nitrogen gas. To start polymerization, 45 mL of the initiator solution was injected into the reaction vessel that had been adjusted to 60° C. During polymerization, ethylene was introduced to maintain the pressure inside the reaction vessel at 3.4 kg/cm² with the polymerization temperature held at 60° C. The initiator solution was continuously added into the reaction vessel at 143 mL/hr to allow polymerization. The reaction vessel was cooled to stop polymerization upon the polymerization conversion rate reaching 50% after 5 hours. After removing ethylene by opening the reaction vessel, nitrogen gas was bubbled to fully remove ethylene. Thereafter, the unreacted vinyl acetate monomer was removed under reduced pressure to yield a methanol solution of polyvinyl acetate. The polyvinyl acetate concentration was adjusted to 25 mass % by adding methanol to the polyvinyl acetate solution. For saponification, 23.3 g of an alkaline solution (a 10 mass % methanol solution of NaOH) was added to 400 g of the methanol solution of polyvinyl acetate (a solution containing 100 g of polyvinyl acetate) in a mole ratio of 0.1 with respect to the vinyl acetate unit in polyvinyl acetate. After about 1 minute from addition of an alkali, the gelled material was pulverized with a pulverizer, and was left to stand at 40° C. for 1 hour to allow saponification to proceed. Thereafter, 1,000 g of methyl acetate was added, and the mixture was left to stand at room temperature for 30 minutes. After filtration, 1,000 g of methanol was added to the resultant white solid (PVA), and the solid was washed by being left to stand at room temperature for 3 hours. After removing the solution by centrifugation, the PVA was left to stand at 100° C. for 3 hours in a dryer to obtain a PVA (PVA 1-1).

### Analysis of Properties of PVA

The PVA (PVA 1-1) was analyzed with respect to degree of saponification, average degree of polymerization, and the fraction of ethylene unit, using the following techniques.

### Degree of Saponification

The PVA (PVA 1-1) had a degree of saponification of 99.5 mol % as measured according to JIS K 6726:1994.

### Average Degree of Polymerization

The methanol solution of polyvinyl acetate obtained by removing the unreacted vinyl acetate monomer after the polymerization of Synthesis Example 1-2 was saponified at an alkali mole ratio of 0.5, and was left to stand at 60° C. for 5 hours after pulverization to allow saponification to proceed. This was followed by Soxhlet extraction with methanol for 3 days, and drying under reduced pressure at 80° C. for 3 days to obtain a purified PVA. The purified PVA had an average degree of polymerization of 2,450 as measured according to JIS K 6726:1994.

### Fraction of Ethylene Unit

The methanol solution of polyvinyl acetate obtained by removing the unreacted vinyl acetate monomer after the polymerization of Synthesis Example 1-2 was purified three times by reprecipitation using n-hexane for precipitation and acetone for dissolution. The product was dried under reduced pressure at 80° C. for 3 days to obtain purified polyvinyl acetate. The purified polyvinyl acetate was dissolved in DMSO-d⁶, and the ethylene unit content was measured at 80° C. with a proton NMR measurement device (JEOL GX-500) at 500 MHz. The purified polyvinyl acetate had an ethylene unit content of 3.0 mol %.

### Synthesis Example 1-3

A PVA (PVA 1-2) was synthesized using a uniform mixture of 30 parts of the plant-derived vinyl acetate of Synthesis Example 1-1 and 70 parts of ordinary petroleum-derived vinyl acetate as raw material, following the same method used in Synthesis Example 1-2 except that ethylene was not introduced. The PVA 1-2 had a degree of saponification of 99.5 mol %, and an average degree of polymerization of 2,640. The ethylene unit was 0 mol %.

### Synthesis Example 1-4

A PVA (PVA 1-3) was synthesized by the same method used in Synthesis Example 1-2, using a raw material that is 100% ordinary petroleum-derived vinyl acetate. The PVA 1-3 had a degree of saponification of 99.6 mol %, and an average degree of polymerization of 2,480. The ethylene unit was 3.0 mol %.

### Synthesis Example 1-5

A PVA (PVA 1-4) was synthesized by the same method used in Synthesis Example 1-3, using a raw material that is 100% ordinary petroleum-derived vinyl acetate. The PVA 1-4 had a degree of saponification of 99.6 mol %, and an average degree of polymerization of 2,580. The ethylene unit was 0 mol %.

### Example 1-1

### Preparation of Cement Slurry

The PVA (PVA 1-1) was sifted using a sieve with a nominal opening of 250 μm (60 mesh). A PVA powder (4 g) that passed through the sieve was introduced into a juice mixer with 320 g of ion-exchange water, 800 g of class H cement for wells, 4 g of a naphthalenesulfonic acid formalin condensate, sodium salt (Daxad-19 from Dipersity Technologies), and 0.16 g of ligninsulfonic acid, sodium salt (Keling 32L from Lignotech USA). These were stirred and mixed to prepare a cement slurry (S-1). The PVA powder was added in an amount of 0.5% in terms of the mass the cement (BWOC). After sieving, the PVA powder has a particle size of less than 250 μm in a particle size distribution (by volume), as noted above.

### Example 1-2

A cement slurry (S-2) was prepared in the same manner as in Example 1-1, except that the PVA (PVA 1-2) was used.

### Reference Example 1-1

A cement slurry (s-1) was prepared in the same manner as in Example 1-1, except that the PVA (PVA 1-3) was used.

### Reference Example 1-2

A cement slurry (s-2) was prepared in the same manner as in Example 1-2, except that the PVA (PVA 1-4) was used.

### Evaluations

The cement slurries (S-1) and (S-2) of Examples 1-1 and 1-2, and the cement slurries (s-1), and (s-2) of Reference Examples 1-1 and 1-2 were evaluated with respect to viscosity, and amount of dehydration, using the techniques below. The evaluation results are presented in Table 1. Table 1 also shows the water solubilities of the PVAs used for the preparation of these cement slurries.

### Solubility in Water

A PVA powder (4 g) was introduced into a 300-mL beaker that had been charged with 100 g of 60° C. water, and was stirred at 280 rpm for 3 hours at 60° C. without causing water to evaporate, using a magnetic stirrer equipped with a 3-cm bar. The undissolved powder was separated with a screen having a nominal opening of 75 μm (200 mesh). The mass of the undissolved PVA powder was measured after 3 hours of drying with a heated-air dryer at 105° C. The solubility of the PVA powder was calculated from the mass of the undissolved PVA powder, and the mass (4 g) of the PVA powder introduced into the beaker.

### Viscosity

Plastic viscosity (PV) and yield value (YV) were evaluated for viscosity evaluation. Plastic viscosity (PV) is a value of fluid resistance due to the mechanical friction of the solids contained in the cement slurry. Yield value (YV) represents the shear force required to maintain constant flow when a fluid is in a fluidized state, and is a measure of a fluid resistance created by the pulling force between solid particles contained in the cement slurry.

Plastic viscosity (PV) and yield value (YV) were measured following the methods described in Appendix H of API 10 (American Institute Specification 10), after adjusting the cement slurry temperature to 25° C. or 90° C. The following formulae were used for the calculations of plastic viscosity (PV) and yield value (YV).

Plastic viscosity (PV)=(reading at 300 rpm−reading at 100 rpm)×1.5

Yield value (YV)=(reading at 300 rpm−plastic viscosity)

Amount of Dehydration

The amount of dehydration was measured as the amount of water lost in 30 minutes when the cement slurry having an adjusted temperature of 90° C. was placed under 1,000 psi differential pressure conditions, following the method described in Appendix H of API 10 (American Institute Specification 10).

TABLE 1

| | Additive for cement slurries | | | Evaluation of cement slurry | | | |
|---|---|---|---|---|---|---|---|
| | | Particle | Solubility | Cement | Viscosity | | Amount of |
| | PVA | size | (%) | slurry | PV (cp) | YV (lb/100 ft) | dehydration (mL) |
| Ex. 1-1 | PVA 1-1 | Passed 250 μm | 17.8 | S-1 | 32 (20° C.) | 2 (20° C.) | 25 |
| | | | | | 48 (90° C.) | 9 (90° C.) | |
| Ex. 1-2 | PVA 1-2 | Passed 250 μm | 15.8 | S-2 | 35 (20° C.) | 3 (20° C.) | 32 |
| | | | | | 54 (90° C.) | 10 (90° C.) | |
| Ref. Ex. 1-1 | PVA 1-3 | Passed 250 μm | 16.9 | s-1 | 35 (20° C.) | 2 (20° C.) | 24 |
| | | | | | 44 (90° C.) | 8 (90° C.) | |
| Ref. Ex. 1-2 | PVA 1-4 | Passed 250 μm | 16.2 | s-2 | 36 (20° C.) | 1 (20° C.) | 33 |
| | | | | | 59 (90° C.) | 10 (90° C.) | |

As is clear from the results presented in Table 1, the cement slurries (S-1) and (S-2) of Examples 1-1 and 1-2 had excellent viscosities, and underwent reduced dehydration at high temperature with 25 mL and 32 mL of dehydration, respectively, at 150° C. These values were comparative to those of the cement slurries (s-1) and (s-2) of Reference Examples 1-1 and 1-2 representing PVAs synthesized from petroleum-derived vinyl acetate alone, showing that the cement slurries (S-1) and (S-2) are as capable as the cement slurries (s-1) and (s-2). Visual inspection confirmed no segregation in the cement slurries (S-1) and (S-2) of Examples 1-1 and 1-2. Such cement slurries can contribute to saving petroleum resources and alleviating global warming.

### Drilling Mud

### Synthesis Example 1-6

### Preparation of PVA (PVA 1-5)

A uniform mixture of 50 parts of the plant-derived vinyl acetate of Synthesis Example 1-1 and 50 parts of ordinary petroleum-derived vinyl acetate was used as raw material to synthesize a PVA, as follows.

A 250-L reaction vessel equipped with a stirrer, a nitrogen inlet, an ethylene inlet, an initiator feed port, and a delay solution feed port was charged with 127.5 kg of vinyl acetate and 22.5 kg of methanol, and, after raising the temperature to 60° C., the mixture was purged with nitrogen by bubbling nitrogen for 30 minutes. Thereafter, ethylene was introduced so as to bring the pressure inside the reaction vessel to 4.9 kg/cm². Separately, a 2.8 g/L reaction initiator solution was prepared by dissolving initiator 2,2′-azobis(4-methoxy-2,4-dimethylvaleronitrile) (AMV) in methanol, purged with nitrogen by bubbling nitrogen gas. To start polymerization, 45 mL of the initiator solution was injected into the reaction vessel that had been adjusted to 60° C. During polymerization, ethylene was introduced to maintain the pressure inside the reaction vessel at 4.9 kg/cm2 with the polymerization temperature held at 60° C. The initiator solution was continuously added into the reaction vessel at 143 mL/hr to allow polymerization. The reaction vessel was cooled to stop polymerization upon the polymerization conversion rate reaching 40% after 4 hours. After removing ethylene by opening the reaction vessel, nitrogen gas was bubbled to fully remove ethylene. Thereafter, the unreacted vinyl acetate monomer was removed under reduced pressure to yield a methanol solution of polyvinyl acetate. The polyvinyl acetate concentration was adjusted to 25 mass % by adding methanol to the polyvinyl acetate solution. For saponification, 23.3 g of an alkaline solution (a 10 mass % methanol solution of NaOH) was added to 400 g of the methanol solution of polyvinyl acetate (a solution containing 100 g of polyvinyl acetate) in a mole ratio of 0.1 with respect to the vinyl acetate unit in polyvinyl acetate. After about 1 minute from addition of an alkali, the gelled material was pulverized with a pulverizer, and was left to stand at 40° C. for 1 hour to allow saponification to proceed. Thereafter, 1,000 g of methyl acetate was added, and the mixture was left to stand at room temperature for 30 minutes. After filtration, 1,000 g of methanol was added to the resultant white solid (PVA), and the solid washed by being left to stand at room temperature for 3 hours. After removing the solution by centrifugation, the PVA was left to stand at 100° C. for 3 hours in a dryer to obtain a PVA (PVA 1-5).

### Analysis of Properties of PVA

The PVA (PVA 1-5) was analyzed with respect to degree of saponification, average degree of polymerization, and the fraction of ethylene unit, using the following techniques.

### Degree of Saponification

The PVA (PVA 1-5) had a degree of saponification of 99.9 mol % as measured according to JIS K 6726:1994.

### Average Degree of Polymerization

The methanol solution of polyvinyl acetate obtained by removing the unreacted vinyl acetate monomer after the polymerization of Synthesis Example 1-6 was saponified at an alkali mole ratio of 0.5, and was left to stand at 60° C. for 5 hours after pulverization to allow saponification to proceed. This was followed by Soxhlet extraction with methanol for 3 days, and drying under reduced pressure at 80° C. for 3 days to obtain a purified PVA. The purified PVA had an average degree of polymerization of 1,720 as measured according to JIS K 6726:1994.

### Ethylene Unit Content

The methanol solution of polyvinyl acetate obtained by removing the unreacted vinyl acetate monomer after the polymerization of Synthesis Example 1-6 was purified three times by reprecipitation using n-hexane for precipitation and acetone for dissolution. The product was dried under reduced pressure at 80° C. for 3 days to obtain purified polyvinyl acetate. The purified polyvinyl acetate was dissolved in DMSO-d⁶, and the fraction of ethylene unit was measured at 80° C. with a 1H-NMR measurement device (JEOL GX-500) at 500 MHz. The fraction of ethylene unit was 5.0 mol %.

### Synthesis Example 1-7

### Preparation of PVA (PVA 1-6)

A PVA (PVA 1-6) was synthesized using a uniform mixture of 30 parts of the plant-derived vinyl acetate of Synthesis Example 1-1 and 70 parts of ordinary petroleum-derived vinyl acetate as raw material, following the same method used in Synthesis Example 1-6 except that ethylene was not introduced. The PVA 1-6 had a degree of saponification of 99.9 mol %, and an average degree of polymerization of 2,520. The ethylene unit was 0 mol %.

### Synthesis Example 1-8

A PVA (PVA 1-7) was synthesized by the same method used in Synthesis Example 1-6, using a raw material that is 100% ordinary petroleum-derived vinyl acetate. The PVA 1-7 had a degree of saponification of 99.9 mol %, and an average degree of polymerization of 1,740. The ethylene unit was 5.0 mol %.

### Synthesis Example 1-9

A PVA (PVA 1-8) was synthesized by the same method used in Synthesis Example 1-7, using a raw material that is 100% ordinary petroleum-derived vinyl acetate. The PVA 1-8 had a degree of saponification of 99.9 mol %, and an average degree of polymerization of 2,480. The ethylene unit was 0 mol %.

### Example 1-3

### Preparation of Drilling Mud

Three-hundred grams of ion-exchange water was taken into the cup of a Hamilton Beach mixer, and six grams of bentonite (Telgel E; Telnite Co., Ltd.) was added. After thorough stirring, the mixture was left to stand for 24 hours to allow bentonite to sufficiently swell. Separately, the PVA (PVA 1-5) was sifted through a sieve having a nominal opening of 1.00 mm (16 mesh), and 1.5 g of a PVA (PVA 1-5) powder that passed through the sieve was collected. The powder was added to the bentonite dispersion to obtain a drilling mud (D-1). After sieving, the PVA powder has a particle size of less than 1.00 mm in a particle size distribution (by volume), as noted above.

### Example 1-4

A drilling mud (D-2) was prepared in the same manner as in Example 1-3, except that a powder of PVA (PVA 1-6) was used.

### Reference Example 1-3

A drilling mud (d-1) was prepared in the same manner as in Example 1-3, except that a powder of PVA (PVA 1-7) was used.

### Reference Example 1-4

A drilling mud (d-2) was prepared in the same manner as in Example 1-3, except that a powder of PVA (PVA 1-8) was used.

### Evaluations

The drilling muds (D-1) and (D-2) and the drilling muds (d-1) and (d-2) were evaluated with respect to viscosity, and amount of dehydration, using the techniques below. The PVAs (PVA 1-5 to PVA 1-8) used for the preparation of these drilling muds were evaluated with respect to solubility in water, following the technique below. The evaluation results are presented in Table 2.

### Solubility in Water

A PVA powder (4 g) was introduced into a 300-mL beaker that had been charged with 100 g of 60° C. water, and was stirred at 280 rpm for 3 hours at 60° C. without causing water to evaporate, using a magnetic stirrer equipped with a 3-cm bar. The undissolved powder was separated with a screen having a nominal opening of 75 μm (200 mesh). The mass of the undissolved PVA powder was measured after 3 hours of drying with a heated-air dryer at 105° C. The solubility of the PVA powder was calculated from the mass of the undissolved PVA powder, and the mass (4 g) of the PVA powder introduced into the beaker.

### Viscosity

The viscosity of the drilling mud was measured at 25° C., 30 rpm, using a B-type viscometer. The value after 10 seconds was chosen as the viscosity of the drilling mud.

### Amount of Dehydration

The amount of dehydration of drilling mud was measured with an HPHT Filter Press Series 387 (Fann Instrument). For measurement, the drilling mud was introduced into the cell having an adjusted temperature of 150° C., and left to stand for 3 hours. The amount of dehydration was then measured by applying pressure from the top and bottom of the cell with a pressure difference of 500 psi.

TABLE 2

| | Additive for drilling mud slurries | | | Evaluation of drilling mud | | |
|---|---|---|---|---|---|---|
| | | Particle | Solubility | Drilling | Viscosity | Amount of |
| | PVA | size | (%) | mud | (mPa · s) | dehydration (mL) |
| Ex. 1-3 | PVA 1-5 | Passed 1.0 mm | 15.0 | D-1 | 10 | 15 |
| Ex. 1-4 | PVA 1-6 | Passed 1.0 mm | 16.8 | D-2 | 10 | 22 |
| Ref. Ex. 1-3 | PVA 1-7 | Passed 1.0 mm | 14.9 | d-1 | 10 | 16 |
| Ref. Ex. 1-4 | PVA 1-8 | Passed 1.0 mm | 16.9 | d-2 | 10 | 23 |

As is clear from the results presented in Table 2, the drilling muds (D-1) and (D-2) of Examples 1-3 and 1-4 had low viscosities, and underwent considerably reduced dehydration at high temperature with less than 25 mL of dehydration at 150° C. These values were comparative to those of the drilling muds (d-1) and (d-2) of Reference Examples 1-3 and 1-4 representing PVAs synthesized from petroleum-derived vinyl acetate alone, showing that the drilling muds (D-1) and (D-2) are as capable as the drilling muds (d-1) and (d-2). Such drilling muds can contribute to saving petroleum resources and alleviating global warming.

### Synthesis Example 2-2

A uniform mixture of 50 parts of the plant-derived vinyl acetate of Synthesis Example 1-1 and 50 parts of ordinary petroleum-derived vinyl acetate was used as raw material. By using methyl acrylate, these were copolymerized with 5 mol % of methyl acrylate to synthesize polyvinyl acetate, following an ordinary method. A methanol solution of this polyvinyl acetate was then used for saponification reaction with an alkali catalyst, and the product was dried to obtain a PVA. The PVA had an average degree of polymerization of 1,450, and a degree of saponification of 99.5 mol %. To the PVA was added 1.5 mass % of polyethylene glycol, and the mixture was kneaded. The product was then extruded into a sheet form under a molding pressure of 1,259 psi, using a biaxial extruder. The shaped product was fed to a granulator, and granulated to a 6/8 mesh (ASTM Ell standards) to obtain a PVA resin pellet (PVA 2-1). Here, “granulate to a 6/8 mesh” means granulating the material to a particle size that passes through a 6 mesh but does not pass through an 8 mesh. Particles granulated to a 6/8 mesh have a particle diameter of 2,380 um or more and 3,350 um or less.

### Synthesis Example 2-3

A PVA was obtained by the same method used in Synthesis Example 2-2, except that a uniform mixture of 30 parts of the plant-derived vinyl acetate of Synthesis Example 1-1 and 70 parts of ordinary petroleum-derived vinyl acetate was used as raw material, and that methyl acrylate was not used for copolymerization. The PVA had an average degree of polymerization of 1, 620, and a degree of saponification of 99.5 mol %. To the PVA was added 1.5 mass % of polyethylene glycol, and the mixture was kneaded. The product was then extruded into a sheet form under a molding pressure of 1,250 psi, using a biaxial extruder. The shaped product was fed to a granulator, and granulated to a 6/8 mesh to obtain a PVA resin pellet (PVA 2-2).

### Synthesis Example 2-4

A PVA resin pellet (PVA 2-3) was synthesized by the same method used in Synthesis Example 2-2, using a raw material that is 100% ordinary petroleum-derived vinyl acetate. The PVA had a degree of saponification of 99.5 mol %, and an average degree of polymerization of 1,480. The methyl acrylate content was 5 mol %.

### Synthesis Example 2-5

A PVA resin pellet (PVA 2-4) was synthesized by the same method used in Synthesis Example 2-3, using a raw material that is 100% ordinary petroleum-derived vinyl acetate. The PVA had a degree of saponification of 99.6 mol %, and an average degree of polymerization of 1,580.

### Examples 2-1 and 2-2 and Reference Examples 2-1 and 2-2

### Sealing Agent for Underground Treatment

The PVA 2-1 to PVA 2-4 obtained were evaluated for sealing effect by measuring a degree of swelling with water (%) and solubility (%) in water, using the methods below. The results are presented in Table 3.

### Degree of Swelling with Water

A PVA resin pellet (0.5 g) was placed in a test tube measuring 18 mm in inner diameter, and the height of the PVA resin pellet in the test tube was measured (height A). Thereafter, 7 mL of distilled water was added into the test tube, and the PVA resin pellet was dispersed by thoroughly shaking the test tube. The test tube was then dipped in a water bath that had been set to 40° C., and the height (height B) of the PVA resin pellet in the test tube was measured after allowing the pellet to stand for 30 minutes from the water in the test tube reaching 40° C. The degree of swelling with water (%) was calculated from the values of the measured height A and height B, using the following formula.

Degree of swelling with water (%)=(height B/height A)×100

### Solubility in Water

A 200-mL glass container with a lid was charged with 100 g of distilled water, and was left to stand in a 65° C. thermostat bath for 5 hours after introducing 6 g of a PVA resin pellet. The content inside the glass container was sifted through a 120 nylon mesh (a sieve with a 125-micron opening), and the PVA resin pellet trapped on the sieve was dried at 140° C. for 3 hours, and the mass of the PVA resin pellet was measured after drying (mass A). Separately, a sample of the same PVA resin pellet was collected for the measurement of percent solids, and was dried at 105° C. for 3 hours. The percent solids were calculated by measuring the mass before drying (mass B) and the mass after drying (mass C). The solubility of the PVA resin pellet in water (%) was then calculated from the percent solids and mass A, using the formula below.

Percent solids (%)=(mass C/mass B)×100

Solubility in water (%)={6−(mass A×100/percent solids)}/6×100

### Test for Confirmation of Sealing Effect

A 120-mesh stainless-steel sieve was installed in a stainless steel column having an inner diameter of 10 mm, and 5 g of a PVA resin pellet was placed on the upstream side. After the column was charged with hot water that had been adjusted to 50° C., a 100 psi pressure was applied. The sealing effect was evaluated by visually observing the column, with “Good” being assigned when the hot water stopped flowing within 15 seconds, and “Poor” when the flow of hot water did not stop within 15 seconds.

TABLE 3

| | | Solubility | Degree of swelling | Sealing |
|---|---|---|---|---|
| | PVA | in water (%) | with water (%) | effect |
| Ex. 2-1 | PVA 2-1 | 78 | 110 | Good |
| Ex. 2-2 | PVA 2-2 | 11 | 180 | Good |
| Ref. Ex. 2-1 | PVA 2-3 | 82 | 120 | Good |
| Ref. Ex. 2-2 | PVA 2-4 | 8 | 200 | Good |

The PVA resin pellets of Examples 2-1 and 2-2 had the solubility and the degree of swelling comparable to the values from their respective Reference Examples 2-1 and 2-2, and were shown to have the same levels of (hot) water solubility and swellability as Reference Examples 2-1 and 2-2. The PVA resin pellets of Examples 2-1 and 2-2 were also shown to exhibit a sufficient sealing effect, and can contribute to saving petroleum resources and alleviating global warming. A sealing agent for underground treatment containing such a PVA gradually dissolves in water while temporarily plugging fractures underground, and does not stay in the ground for prolonged time periods because it is removed during or after underground resources such as petroleum and natural gas are recovered, making it possible to reduce the burden placed on the environment.

### Synthesis Example 2-6

A PVA was obtained by the same method used in Synthesis Example 2-3, using a raw material prepared with 100 parts of the plant-derived vinyl acetate obtained in Synthesis Example 1-1, without adding any ordinary petroleum-derived vinyl acetate.

The PVA had an average degree of polymerization of 1, 580, and a degree of saponification of 99.6 mol %. To the PVA was added 1.5 mass % of polyethylene glycol, and the mixture was kneaded. The product was then extruded into a sheet form under a molding pressure of 1,250 psi, using a biaxial extruder. The shaped product was fed to a granulator, and granulated to a 6/8 mesh to obtain a PVA resin pellet (PVA 2-5).

### Comparative Example 2-1

The PVA 2-5 had cracks in the exterior, in contrast to the smooth exterior of PVA 2-3 produced by the same method. Though the reason for this observation remains somewhat unclear, it has been confirmed that cracking in PVA can be reduced when the raw material contains 10 mol % or more of plant-derived vinyl acetate.

By using the plant-derived vinyl ester monomer (A) as a monomer, the present invention produced a vinyl alcohol polymer having properties comparable to a vinyl alcohol polymer of solely petroleum origin. It was confirmed that the present invention can reduce the manufacturing problems involved in the production of PVA. In using the PVA, the present invention can also save petroleum resources, and reduce carbon dioxide emissions in production processes.

### Synthesis Example 3-2

A uniform mixture of 50 parts of the plant-derived vinyl acetate of Synthesis Example 1-1 and 50 parts of ordinary petroleum-derived vinyl acetate was used as raw material to synthesize polyvinyl acetate following an ordinary method under desirably adjusted polymerization conditions, including polymerization temperature and polymerization time. A methanol solution of this polyvinyl acetate was used for saponification reaction with an alkali catalyst following an ordinary method, after desirably adjusting saponification conditions such as an amount of alkali catalyst, and saponification time. The product was dried to obtain a PVA (PVA 3-1). The PVA had an average degree of polymerization of 1,750, and a degree of saponification of 88.5 mol %.

### Synthesis Example 3-3

A PVA (PVA 3-2) was obtained by the same method used in Synthesis Example 3-2, except that a uniform mixture of 30 parts of the plant-derived vinyl acetate of

Synthesis Example 1-1 and 70 parts of ordinary petroleum-derived vinyl acetate was used as raw material, and that ordinary petroleum-derived ethylene was copolymerized. The PVA had an average degree of polymerization of 1, 720, and a degree of saponification of 97.5 mol %. The ethylene content was 4.2 mol %.

### Synthesis Example 3-4

A PVA resin (PVA 3-3) was synthesized by the same method used in Synthesis Example 3-2, using a raw material that is 100% ordinary petroleum-derived vinyl acetate.

The PVA had a degree of saponification of 88.7 mol %, and an average degree of polymerization of 1,780.

### Synthesis Example 3-5

A PVA resin (PVA 3-4) was synthesized by the same method used in Synthesis Example 3-3, using a raw material that is 100% ordinary petroleum-derived vinyl acetate.

The PVA had a degree of saponification of 98.1 mol %, and an average degree of polymerization of 1,680. The ethylene content was 4.1 mol %.

### Example 3-1

The PVA 3-1 was used to prepare an aqueous emulsion using the method below, and was evaluated with respect to the presence or absence of formation of aggregates, normal bonding capability, and spreadability.

### Preparation of Aqueous Emulsion

A 1-liter glass polymerization vessel equipped with a reflux condenser, a dropping funnel, a thermometer, and a nitrogen inlet was charged with 275 g of ion-exchange water, and heated to 85° C. After dispersing 20.9 g of PVA-1, the mixture was stirred for 45 minutes to dissolve PVA-1. Thereafter, 0.3 g of sodium acetate was added, and mixed to dissolve. The aqueous solution of PVA-1 was cooled, and, after being purged with nitrogen, heated to 60° C. with stirring at 200 rpm. To start polymerization, 27 g of vinyl acetate was fed after adding 2.4 g of a 20 mass % aqueous solution of tartaric acid and 3.2 g of a 5 mass % hydrogen peroxide solution to the aqueous solution in shots. Completion of initial polymerization (less than 1% of vinyl acetate is remaining) was confirmed after 30 minutes from the start of polymerization. The polymerization was allowed to proceed to completion at a maintained polymerization temperature of 80° C. by continuously adding 251 g of vinyl acetate for 2 hours after shot addition of 1 g of a 10 mass % aqueous solution of tartaric acid and 3.2 g of a 5 mass % hydrogen peroxide solution. This produced a polyvinyl acetate emulsion (Em-1) having a solids concentration of 49.8 mass %.

### Amount of Aggregate Formation

The aqueous emulsion (500 g) obtained in each Example and Reference Example was filtered through a 60-mesh screen, and the residue was weighed for evaluation, as follows.

A: Residue is less than 1.0 mass %

B: Residue is 1.0 mass % or more and less than 2.5 mass %

C: Residue is 2.5 mass % or more and less than 5.0 mass %

D: Residue is 5.0 mass % or more; filtration is difficult

### Normal Adhesive Properties

Normal adhesive properties were evaluated in compliance with JIS K 6852 (1994).

### Bonding Conditions

Adherend: Tsuga/tsuga (Tsuga sieboldii)
Spread: 150 g/m2 (applied to both surfaces)
Pressing conditions: 20° C., 24 hours, 10 kg/cm² pressure

### Measurement Conditions

A specimen after 7 days of aging in a 20° C., 65% RH environment was subjected to a compression shear test, and the bond strength (unit: kgf/cm²) was measured.

### Spreadability

The aqueous emulsion (0.8 g) was dropped on birch wood measuring 25 mm in width and 20 cm in length, and rubbed four times with a rubber roller to see any changes. Evaluations were made in the scale of A to D with the following criteria.

A: Uniform coating over the whole surface of birch wood; no aggregate formation

B: Uniform coating over more than half of the birch wood surface area; no aggregate formation or peeling of the coating

C: Coating over more than half of the birch wood surface area; aggregate formation and peeling of the coating are present

D: Coating over less than half of the birch wood surface area; aggregate formation and peeling of the coating are present

### Example 3-2 and Reference Examples 3-1 and 3-2

Aqueous emulsions were prepared in the same manner as in Example 3-1, except that PVA-2, PVA-3, and PVA-4 were used in place of the copolymer 1 of Example 3-1. The aqueous emulsions (Em-2 to Em-4) obtained were evaluated with respect to amount of aggregate formation, normal adhesive properties, and spreadability, following the methods described above. The results are summarized in Table 4.

TABLE 4

| | | | | Normal | |
|---|---|---|---|---|---|
| | | | | adhesive | |
| | Aqueous | | Aggregate | properties | Spread- |
| | emulsion | PVA | formation | (kgf/cm²) | ability |
| Ex. 3-1 | Em-1 | PVA 3-1 | A | 117 | A |
| Ex. 3-2 | Em-2 | PVA 3-2 | A | 120 | B |
| Ref. Ex. 3-1 | Em-3 | PVA 3-3 | A | 122 | A |
| Ref. Ex. 3-1 | Em-4 | PVA 3-4 | A | 101 | B |

The aqueous emulsions obtained by using the PVAs of Examples 3-1 and 3-2 as dispersion stabilizers for emulsion polymerization had no formation of aggregates, and the normal adhesive properties were comparable to those of their respective Reference Examples 3-1 and 3-2, confirming that the aqueous emulsions of Examples 3-1 and 3-2 exhibit the same levels of adhesion as the aqueous emulsions of Reference Examples 3-1 and 3-2. The aqueous emulsions of Examples 3-1 and 3-2 also showed sufficient spreadability, an important index in adhesive agent applications. Such aqueous emulsions can contribute to saving petroleum resources and alleviating global warming.

### Synthesis Example 4-2

### Polyvinyl Alcohol Polymer

A uniform mixture of 50 parts of the plant-derived vinyl acetate of Synthesis Example 1-1 and 50 parts of ordinary petroleum-derived vinyl acetate was used as raw material to synthesize polyvinyl acetate following an ordinary method. A methanol solution of this polyvinyl acetate was used for saponification reaction with an alkali catalyst, and the product was dried to obtain a PVA (PVA 4-1). The PVA, obtained by desirably changing the production conditions (polymerization conditions, saponification conditions) from those used in Synthesis Example 3-2, had an average degree of polymerization of 1,700, and a degree of saponification of 98.5 mol %.

### Synthesis Example 4-3

A uniform mixture of 30 parts of the plant-derived vinyl acetate of Synthesis Example 1-1 and 70 parts of ordinary petroleum-derived vinyl acetate was used as raw material to obtain a PVA (PVA 4-2), using the same method used in Synthesis Example 4-2. The PVA had an average degree of polymerization of 2,400, and a degree of saponification of 88.0 mol %.

### Synthesis Example 4-4

A PVA resin pellet (PVA 4-3) was synthesized by the same method used in Synthesis Example 4-2, using a raw material that is 100% ordinary petroleum-derived vinyl acetate. The PVA had a degree of saponification of 98.5 mol %, and an average degree of polymerization of 1,700.

### Synthesis Example 4-5

A PVA resin pellet (PVA 4-4) was synthesized by the same method used in Synthesis Example 4-3, using a raw material that is 100% ordinary petroleum-derived vinyl acetate. The PVA had a degree of saponification of 88.0 mol %, and an average degree of polymerization of 2,400.

### Examples 4-1 and 4-2 and Reference Examples 4-1 and 4-2

The PVA 4-1 to PVA 4-4 obtained were evaluated as coating agents by making measurements according to the dust removal procedures, seed germination at room temperature, germination test, accelerated aging test, and flowability described below. The results are presented in the table.

### Treatment of Soybean Seed

A seed coating composition was prepared according to Table 5. Soybean seeds were treated with a base mixture of AccelronTm package (Monsanto Company; containing metalaxyl, pyraclostrobin, imidacloprid, and fluxapyroxad), color coat red, and water to achieve the rate of 5.8 fl. oz/cwt for the AccelronTM package. For application, 15.64 mL of a slurry was applied to 2,400 g of seeds.

TABLE 5

| Sample (Rate fl oz) | Slurry (fl. oz/cwt) | mL/pound |
|---|---|---|
| Coating #1 | Acceleron ™ package 5.8 | 20.5807 |
| | PVA 0.75 | 2.6613 |
| | Water 4.2 | 12.2420 |
| | Total 10.75 | 35.4840 |
| Coating #2 | Acceleron ™ package 5.8 | 20.5807 |
| | PVA 2.25 | 7.9839 |
| | Water 1.95 | 6.9194 |
| | Total 10.0 | 35.484 |

### Dust Removal Procedures

The dry soybean seeds after treatment were placed in a closed-system container installed with a filter, and agitated by applying vibration in vacuum. Air was introduced into the container, and discharged through the filer to trap dust. The measured amounts of dust on the filter are presented in Table 6. The amount of generated dust was small with the seed coating compositions of Examples 4-1 and 4-2, confirming that the seed coating compositions of Examples 4-1 and 4-2 were comparable to the seed coating compositions of their respective Reference Examples 4-1 and 4-2.

TABLE 6

| | | Coating | Average gram of |
|---|---|---|---|
| | PVA | composition | dust/100,000 seeds |
| Ex. 4-1 | PVA 4-1 | #1 | 0.0071 |
| Ex. 4-2 | PVA 4-1 | #2 | 0.0062 |
| Ex. 4-3 | PVA 4-2 | #1 | 0.0079 |
| Ref. Ex. 4-1 | PVA 4-3 | #1 | 0.0072 |
| Ref. Ex. 4-2 | PVA 4-3 | #2 | 0.0062 |
| Ref. Ex. 4-3 | PVA 4-4 | #1 | 0.0080 |

### Seed Germination at Room Temperature

This test was conducted to determine the maximum germination capacity of untreated seeds and seeds after treatment. Four sets of one-hundred seeds were prepared, and the seeds were planted in wetted cellulose crepe paper. After 7 days at 25° C., the seedlings were evaluated as “normal”, “abnormal”, or “dead” according to the rules of AOSA (The Association of Official Seed Analysts). Normal germination was determined as a percentage by subtracting the number of abnormal or dead seeds from the average number of seeds that germinated in the duration of the test, and dividing the result by the total number of original seeds. The results are presented in the Table 7 below. The seed coating compositions of Examples 4-1 and 4-2 did not have harmful effects on germination rate under the ideal conditions, confirming that the seed coating compositions of Examples 4-1 and 4-2 were comparable to the seed coating compositions of their respective Reference Examples 4-1 and 4-2.

TABLE 7

| | PVA | Coating | Normal | Abnormal | Dead |
|---|---|---|---|---|---|
| Ex. 4-1 | PVA 4-1 | Coating #1 | 96 | 4 | 0 |
| Ex. 4-2 | PVA 4-1 | Coating #2 | 95 | 4 | 1 |
| Ref. Ex. 4-1 | PVA 4-3 | Coating #1 | 96 | 4 | 0 |
| Ref. Ex. 4-2 | PVA 4-3 | Coating #2 | 95 | 4 | 1 |

### Low-Temperature Germination Test

This test was designed to measure the germination capacity of seeds under poor conditions involving high soil moisture, low soil temperature, and microbial activity. Four sets of one-hundred seeds were prepared, and the seeds were planted in wetted cellulose crepe paper, and covered with sand. The cover tray was kept at 10° C. for 7 days, and the plant was transferred and kept at 25° C. for 4 days. Normal seedlings were determined by evaluation based on the rules of AOSA, taking into consideration vitality. Normal germination was determined as a percentage by subtracting the number of abnormal or dead seeds from the average number of seeds that germinated in the duration of the test, and dividing the result by the total number of original seeds. The results are presented in the Table 8 below. The low-temperature germination test confirmed that the seed coating compositions of Examples 4-1 and 4-2 were comparable to the seed coating compositions of their respective Reference Examples 4-1 and 4-2 with respect to percent normal germination.

TABLE 8

| | PVA | Coating | Normal |
|---|---|---|---|
| Ex. 4-1 | PVA 4-1 | Coating #1 | 83 |
| Ex. 4-2 | PVA 4-1 | Coating #2 | 86 |
| Ref. Ex. 4-1 | PVA 4-3 | Coating #1 | 83 |
| Ref. Ex. 4-2 | PVA 4-3 | Coating #2 | 86 |

### Accelerated Aging Test

Seeds were weighed, and placed in a chamber equipped with a water jacket.

The chamber was maintained at 43° C. in high humidity for 72 hours. Four sets of one-hundred seeds were prepared, and the seeds were planted in wetted cellulose crepe paper, and covered with sand. The cover tray was kept at 25° C. for 7 days, and normal seedlings were determined by evaluation based on the rules of AOSA. Normal germination was determined as a percentage by subtracting the number of arbitrary abnormal or dead seeds from the average number of seeds that germinated in the duration of the test, and dividing the result by the total number of original seeds. The results are presented in the Table 9 below. The seed coating compositions of Examples 4-1 and 4-2 did not reduce germination, confirming that the seed coating compositions of Examples 4-1 and 4-2 were comparable to the seed coating compositions of their respective Reference Examples 4-1 and 4-2

TABLE 9

| | PVA | Coating | Normal |
|---|---|---|---|
| Ex. 4-1 | PVA 4-1 | Coating #1 | 71 |
| Ex. 4-2 | PVA 4-1 | Coating #2 | 78 |
| Ref. Ex. 4-1 | PVA 4-3 | Coating #1 | 71 |
| Ref. Ex. 4-2 | PVA 4-3 | Coating #2 | 78 |

### Flowability

The dry flow of soybean was measured as the time required for 1,200 g of seeds (300 g×4 sets) to flow through a funnel at 56% relative humidity at 25° C. An undesirable characteristic of adding a coating to soybean is that it tends to considerably slow the seed flow. As shown in Table 9, the seed flow with the seed coating compositions according to the present invention was as effective and as fast as that observed for the seeds of Reference Examples 4-1 and 4-2, confirming that the seed coating compositions according to the present invention were comparable to the seed coating compositions of their respective Reference Examples 4-1 and 4-2.

Bridging of seeds occurs when the seeds discharged from the coater and collected in a storage hopper become compressed by opposing seeds. This poses challenges to seed treatment facilities in terms of device interruption, labor, and time. As shown in Table 10, the use of the seed coating compositions according to the present invention did not result in a tendency for bridging, confirming that the seed coating compositions according to the present invention were comparable to the seed coating compositions of their respective Reference Examples 4-1 and 4-2.

TABLE 10

| | | | Mean | |
|---|---|---|---|---|
| | | | value of | Visual |
| | PVA | Coating | flowability | evaluation |
| Ex. 4-1 | PVA 4-1 | Coating #1 | 2.40 | No observable |
| | | | | bridging |
| Ex. 4-2 | PVA 4-1 | Coating #2 | 2.21 | No observable |
| | | | | bridging |
| Ref. Ex. 4-1 | PVA 4-3 | Coating #1 | 2.41 | No observable |
| | | | | bridging |
| Ref. Ex. 4-2 | PVA 4-3 | Coating #2 | 2.22 | No observable |
| | | | | bridging |

### Synthesis Example 5-2

### Dispersion Stabilizer for Suspension Polymerization

A uniform mixture of 50 parts of the plant-derived vinyl acetate of Synthesis Example 1-1 and 50 parts of ordinary petroleum-derived vinyl acetate was used as raw material to synthesize polyvinyl acetate following an ordinary method, using acetaldehyde as a chain transfer agent. A methanol solution of this polyvinyl acetate was used for saponification reaction with an alkali catalyst, and the product was dried to obtain a PVA (PVA 5-1). The PVA had an average degree of polymerization of 750, and a degree of saponification of 72.0 mol %.

### Synthesis Example 5-3

A uniform mixture of 50 parts of the plant-derived vinyl acetate of Synthesis Example 1-1 and 50 parts of ordinary petroleum-derived vinyl acetate was used as raw material to synthesize polyvinyl acetate following an ordinary method. A methanol solution of this polyvinyl acetate was used for saponification reaction with an alkali catalyst, and the product was dried to obtain a PVA (PVA 5-2). The PVA, obtained by desirably changing the production conditions (polymerization conditions, saponification conditions) from those used in Synthesis Example 3-2, had an average degree of polymerization of 2,400, and a degree of saponification of 80.0 mol %.

### Synthesis Example 5-4

A PVA (PVA 5-3) was synthesized by the same method used in Synthesis Example 5-2, using a raw material that is 100% ordinary petroleum-derived vinyl acetate. 25 The PVA had an average degree of polymerization of 750, and a degree of saponification of 72.0 mol %.

### Synthesis Example 5-5

A PVA (PVA 5-4) was synthesized by the same method used in Synthesis Example 5-3, using a raw material that is 100% ordinary petroleum-derived vinyl acetate. The PVA had an average degree of polymerization of 2,400, and a degree of saponification of 80.0 mol %.

TABLE 11

| | | Plant | Petroleum | Degree | Degree of | Chain |
|---|---|---|---|---|---|---|
| | | origin | origin | of | saponification | transfer |
| | PVA | (parts) | (parts) | polymerization | (mol %) | agent |
| Synthesis | PVA 5-1 | 50 | 50 | 750 | 72 | Acetaldehyde |
| Example 5-2 | | | | | | |
| Synthesis | PVA 5-2 | 50 | 50 | 2400 | 80 | |
| Example 5-3 | | | | | | |
| Synthesis | PVA 5-3 | 0 | 100 | 750 | 72 | Acetaldehyde |
| Example 5-4 | | | | | | |
| Synthesis | PVA 5-4 | 0 | 100 | 2400 | 80 | |
| Example 5-5 | | | | | | |

### Examples 5-1 and 5-2 and Reference Examples 5-1 and 5-2

The PVA 5-1 to PVA 5-4 were used for suspension polymerization of vinyl chloride by the method below. The vinyl chloride polymer particles produced were evaluated with respect to average particle diameter, amount of coarse particles, and plasticizer absorbability. The evaluation results are presented in Table 12.

### Suspension Polymerization of Vinyl Chloride

The vinyl alcohol copolymer obtained above was dissolved in deionized water to prepare an aqueous solution of dispersion stabilizer. Here, the vinyl alcohol copolymer was dissolved in an amount that translates into 800 ppm with respect to vinyl chloride. The aqueous solution of dispersion stabilizer (1,150 g) obtained in this fashion was fed into a 5-L autoclave. Thereafter, 1.5 g of a 70% toluene solution of diisopropylperoxydicarbonate was fed into the autoclave. After removing oxygen by deaeration until the pressure inside the autoclave reached 0.0067 MPa, 1,000 g of vinyl chloride was fed into the autoclave, and the contents in the autoclave were brought to 57 in temperature to initiate polymerization with stirring. The pressure inside the autoclave was 0.83 MPa at the start of polymerization. Polymerization was stopped upon the pressure inside the autoclave reaching 0.44 MPa after 7 hours from the start of polymerization, and the unreacted vinyl chloride was removed. After polymerization, the slurry was taken out, and dried overnight at 65° C. to obtain vinyl chloride polymer particles.

### Evaluation of Vinyl Chloride Polymer Particles

### (1) Average Particle Diameter of Vinyl Chloride Polymer Particles

A particle size distribution was measured by dry sieve analysis with a Tyler mesh standard screen, and the results were plotted using the Rosin-Rammler distribution function to calculate the average particle diameter (dₚ₅₀; median size).

### (2) Amount of Coarse Vinyl Chloride Polymer Particles

The content on a 42-mesh JIS standard sieve was represented in mass %. Smaller values mean fewer coarse particles, and superior polymerization stability.

### (3) Plasticizer Absorbability (CPA)

The mass of a 5-mL syringe packed with 0.02 g of absorbent cotton was measured (mass A (g)), and the mass of the syringe was measured after placing 0.5 g of vinyl chloride polymer particles (mass B (g)). After placing 1 g of dioctyl phthalate (DOP), the syringe was left to stand for 15 minutes, and centrifuged at 3,000 rpm for 40 minutes before measuring the mass (mass C (g)). Plasticizer absorbability (%) was determined using the following mathematical formula.

Plasticizer absorbability (%)=100×[{(C−A)/(B−A)}−1]

TABLE 12

| | | Average | Amount of | |
|---|---|---|---|---|
| | | particle | coarse | Plasticizer |
| | | diameter | particles | absorbability |
| | PVA | (μm) | (%) | (%) |
| Ex. 5-1 | PVA 5-1 | 155 | 0.5 | 26.0 |
| Ex. 5-2 | PVA 5-2 | 140 | 0.2 | 15.0 |
| Ref. Ex. 5-1 | PVA 5-3 | 156 | 0.6 | 25.9 |
| Ref. Ex. 5-2 | PVA 5-4 | 141 | 0.2 | 14.8 |

The average particle diameter, amount of coarse particles, and plasticizer absorbability of the vinyl chloride polymer particles of the PVA resins of Examples 5-1 and 5-2 were comparable to the values obtained in Reference Examples 5-1 and 5-2, confirming that the vinyl chloride polymer particles of Examples 5-1 and 5-2 were as capable as the vinyl chloride polymer particles of their respective Reference Examples 5-1 and 5-2 as dispersion stabilizers for suspension polymerization. Such dispersion stabilizers for suspension polymerization can contribute to saving petroleum resources and alleviating global warming.

### Synthesis Example 6-2

### Auxiliary Dispersion Stabilizer for Suspension Polymerization

A uniform mixture of 50 parts of the plant-derived vinyl acetate of Synthesis

Example 1-1 and 50 parts of ordinary petroleum-derived vinyl acetate was used as raw material to synthesize polyvinyl acetate following an ordinary method. A methanol solution of this polyvinyl acetate was used for saponification reaction with an alkali catalyst, and the product was dried to obtain a PVA (PVA 6-1). The PVA, obtained by desirably changing the production conditions (polymerization conditions, saponification conditions) from those used in Synthesis Example 3-2, had an average degree of polymerization of 300, and a degree of saponification of 55.0 mol %.

### Synthesis Example 6-3

A uniform mixture of 50 parts of the plant-derived vinyl acetate of Synthesis Example 1-1 and 50 parts of ordinary petroleum-derived vinyl acetate was used as raw material to synthesize polyvinyl acetate following an ordinary method, using 3-mercaptopropionic acid (3-MPA) as a chain transfer agent. A methanol solution of this polyvinyl acetate was used for saponification reaction with an alkali catalyst, and the product was dried to obtain a PVA (PVA 6-2). The PVA had an average degree of polymerization of 500, and a degree of saponification of 40.0 mol %.

### Synthesis Example 6-4

A PVA (PVA 6-3) was synthesized by the same method used in Synthesis Example 6-2, using a raw material that is 100% ordinary petroleum-derived vinyl acetate. The PVA had an average degree of polymerization of 300, and a degree of saponification of 55.0 mol %.

### Synthesis Example 6-5

A PVA resin pellet (PVA 6-4) was synthesized by the same method used in Synthesis Example 6-3, using a raw material that is 100% ordinary petroleum-derived vinyl acetate. The PVA had an average degree of polymerization of 500, and a degree of saponification of 40.0 mol %.

### Synthesis Example 6-6

### Dispersion Stabilizer for Suspension Polymerization

Polyvinyl acetate was synthesized following an ordinary method, using a raw material that is 100% ordinary petroleum-derived vinyl acetate. A methanol solution of this polyvinyl acetate was used for saponification reaction with an alkali catalyst, and the product was dried to obtain a PVA (PVA 6-5). The PVA had an average degree of polymerization of 2,000, and a degree of saponification of 80 mol %.

TABLE 13

| | | Plant | Petroleum | Degree | Degree of | Chain |
|---|---|---|---|---|---|---|
| | | origin | origin | of | saponification | transfer |
| | PVA | (parts) | (parts) | polymerization | (mol %) | agent |
| Synthesis | PVA 6-1 | 50 | 50 | 300 | 55 | |
| Example 6-2 | | | | | | |
| Synthesis | PVA 6-2 | 50 | 50 | 500 | 40 | 3-MPA |
| Example 6-3 | | | | | | |
| Synthesis | PVA 6-3 | 0 | 100 | 300 | 55 | |
| Example 6-4 | | | | | | |
| Synthesis | PVA 6-4 | 0 | 100 | 500 | 40 | 3-MPA |
| Example 6-5 | | | | | | |
| Synthesis | PVA 6-5 | 0 | 100 | 2000 | 80 | |
| Example 6-6 | | | | | | |

### Examples 6-1 and 6-2 and Reference Examples 6-1 and 6-2

The PVA 6-1 to PVA 6-4 were used for suspension polymerization of vinyl chloride by the method below. The vinyl chloride polymer particles produced were evaluated with respect to (1) average particle diameter, (2) plasticizer absorbability, (3) monomer removability, and (4) fisheyes. The evaluation results are presented in Table 14.

### Preparation Example 1 of Aqueous Solution of Auxiliary Dispersion Stabilizer for Suspension Polymerization

The PVA, methanol, and distilled water were mixed so as to give 40 mass % of PVA 6-1 or PVA 6-3 (Table 13) and 5 mass % of methanol. The mixture was then stirred at room temperature for 2 hours with a magnetic stirrer to obtain an aqueous solution of auxiliary dispersion stabilizer for suspension polymerization.

### Preparation Example 2 of Aqueous Solution of Auxiliary Dispersion Stabilizer for Suspension Polymerization

The PVA and distilled water were mixed so as to give 5 mass % of PVA 6-2 or PVA 6-4 (Table 13). The mixture was then stirred at room temperature for 2 hours with a magnetic stirrer to obtain an aqueous solution of auxiliary dispersion stabilizer for suspension polymerization.

### Suspension Polymerization of Vinyl Chloride

A dispersion stabilizer for suspension polymerization having a viscosity-average degree of polymerization of 2,000 and a degree of saponification of 80 mol % (PVA 6-5) was charged into a 5-L autoclave by feeding 100 parts of a deionized water solution thereof so as to give 1,000 ppm of PVA 6-5 with respect to vinyl chloride monomer. Thereafter, the aqueous solution of auxiliary dispersion stabilizer for suspension polymerization obtained in Preparation Example 1 was fed so as to give 200 ppm of PVA 6-1 in the aqueous solution of auxiliary dispersion stabilizer with respect to vinyl chloride monomer. Additionally, deionized water was fed to make the total amount of deionized water 1,640 parts. Thereafter, 1.07 parts of a 70% toluene solution of di(2-ethylhexyl)peroxydicarbonate was fed into the autoclave. This was followed by introduction of nitrogen to bring the pressure inside the autoclave to 0.2 MPa, and the nitrogen in the autoclave was purged. After repeating this procedure five times to thoroughly remove oxygen in the autoclave by nitrogen purging, 940 parts of vinyl chloride was fed, and the contents in the autoclave were brought to 65° C. to initiate polymerization of the vinyl chloride monomer with stirring. The pressure inside the autoclave was 1.05 MPa at the start of polymerization. Polymerization was stopped upon the pressure inside the autoclave reaching 0.70 MPa after about 3 hours from the start of polymerization, and the unreacted vinyl chloride monomer was removed. After the polymerization reaction, the product was taken out, and dried at 65° C. for 16 hours to obtain vinyl chloride polymer particles.

### Evaluation of Vinyl Chloride Polymer Particles

### (1) Average Particle Diameter of Vinyl Chloride Polymer Particles

A particle size distribution was measured by dry sieve analysis with a Tyler mesh standard screen, and the results were plotted using the Rosin-Rammler distribution function to calculate the average particle diameter (dp50; median size).

### (2) Plasticizer Absorbability

The mass of a 5-mL syringe packed with 0.02 g of absorbent cotton was measured (mass A (g)), and the mass of the syringe was measured after placing 0.5 g of vinyl chloride polymer particles (mass B (g)). After placing 1 g of dioctyl phthalate (DOP), the syringe was left to stand for 15 minutes, and centrifuged at 3,000 rpm for 40 minutes before measuring the mass (mass C (g)). Plasticizer absorbability (%) was determined using the following mathematical formula.

Plasticizer absorbability (%)=100×[{(C−A)/(B−A)}−1]

### (3) Monomer Removability (Fraction of Residual Monomer)

The product of polymerization in the suspension polymerization of vinyl chloride was taken out, and dried at 75° C. for 1 hour, and, continuously, 3 hours. The amount of residual monomer at each time point was measured by headspace gas chromatography, and the fraction of residual monomer was determined using the following formula.

Fraction of residual monomer =(amount of residual monomer after 3 hours of drying/amount of residual monomer after 1 hour of drying)×100

Smaller fractions of residual monomer mean that the drying removed greater portions of remaining monomer in the vinyl chloride polymer particles in 2 hours of drying between hour 1 and hour 3. This value represents ease of removal of residual monomer, or an index of monomer removability.

### (4) Measurement of Fisheyes

A 0.1 mm-thick sheet was prepared by mixing 100 parts of vinyl chloride polymer particles produced, 35 parts of DOP (dioctyl phthalate), 5 parts of tribasic lead sulfate, and 1 part of zinc stearate at 150° C. for 7 minutes using a roll kneader. The sheet was then measured for number of fisheyes per 100 mm×100 mm area.

TABLE 14

| | | Average | Plasticizer | Monomer | |
|---|---|---|---|---|---|
| | | particle | absorb- | remov- | |
| | | diameter | ability | ability | Fisheyes |
| | PVA | (μm) | (%) | (%) | (count) |
| Ex. 6-1 | PVA 6-1 | 155 | 24.8 | 2.0 | 8 |
| Ex. 6-2 | PVA 6-2 | 142 | 28.2 | 0.5 | 1 |
| Ref. Ex. 6-1 | PVA 6-3 | 156 | 24.5 | 2.2 | 9 |
| Ref. Ex. 6-2 | PVA 6-4 | 141 | 28.0 | 0.5 | 1 |

The average particle diameter, plasticizer absorbability, monomer removability, and fisheyes of the vinyl chloride polymer particles of the PVA resins of Examples 6-1 and 6-2 were comparable to the values obtained in their respective Reference Examples 6-1 and 6-2, confirming that the vinyl chloride polymer particles of Examples 6-1 and 6-2 were as capable as the vinyl chloride polymer particles of Reference Examples 6-1 and 6-2 as auxiliary dispersion stabilizers for suspension polymerization. This contributes to saving petroleum resources and alleviating global warming.

### Synthesis Example 7-2

A uniform mixture of 50 parts of the plant-derived vinyl acetate of Synthesis Example 1-1 and 50 parts of ordinary petroleum-derived vinyl acetate was used as raw material to synthesize polyvinyl acetate following an ordinary method. A methanol solution of this polyvinyl acetate was used for saponification reaction with an alkali catalyst, and the product was dried to obtain a PVA (PVA 7-1). The PVA, obtained by desirably changing the production conditions (saponification conditions) from those used in Synthesis Example 3-2, had an average degree of polymerization of 1,750, and a degree of saponification of 98.5 mol %.

### Synthesis Example 7-3

A PVA (PVA 7-2) was obtained using the same method used in Synthesis Example 7-2, except that a uniform mixture of 30 parts of the plant-derived vinyl acetate of Synthesis Example 1-1 and 70 parts of ordinary petroleum-derived vinyl acetate was used as raw material, and that ordinary petroleum-derived ethylene was copolymerized. The PVA had an average degree of polymerization of 1, 720, and a degree of saponification of 97.5 mol %. The ethylene unit content was 4.2 mol %.

### Synthesis Example 7-4

A PVA resin (PVA 7-3) was synthesized by the same method used in Synthesis Example 7-2, using a raw material that is 100% ordinary petroleum-derived vinyl acetate. 30 The PVA had a degree of saponification of 98.7 mol %, and an average degree of polymerization of 1,780.

### Synthesis Example 7-5

A PVA resin (PVA 7-4) was synthesized by the same method used in Synthesis Example 7-3, using a raw material that is 100% ordinary petroleum-derived vinyl acetate. The PVA had a degree of saponification of 98.1 mol %, and an average degree of polymerization of 1,680. The ethylene content was 4.1 mol %.

### Oxygen Gas Barrier Properties

Multilayer structures obtained in Examples and Comparative Examples were humidified under 20° C., 85% RH conditions for 5 days, and were measured for oxygen transmission rate (cc/m2dayatm) with an oxygen transmission rate measurement device (MOCON OX-TRAN 2/21, manufactured by MOCON).
Temperature: 20° C.
Humidity on oxygen supply side: 85% RH
Humidity on carrier gas side: 85% RH
Flow rate of carrier gas: 10 mL/min
Oxygen pressure: 1.0 atm
Carrier gas pressure: 1.0 atm

### Example 7-1

### Production of Multilayer Structure

The PVA 7-1 was used to produce a multilayer structure using the method below, and the oxygen gas barrier properties (oxygen transmission rate) were evaluated.

One-hundred parts by mass of the vinyl alcohol polymer obtained was added to water to prepare a 7 mass % aqueous solution of vinyl alcohol polymer (coating agent), and this aqueous solution was left to stand at 20° C., 60% RH for 1 hour. An anchor coating agent (adhesive agent) was coated over the layer (D) of a 15 um-thick oriented polyethylene terephthalate (OPET) film (substrate) to form an adhesive component layer on the surface of the OPET film. Thereafter, the coating agent obtained was coated over the surface of the adhesive component layer at 40° C. with a gravure coater, and was dried at 120° C. to form a layer (C). The film was subjected to another heat treatment at 160° C. for 120 seconds to accelerate the reaction of the anchor coating agent, and obtain a multilayer structure. The layer (C) had a thickness of 2 μm. The oxygen transmission rate of the multilayer structure is presented in Table 15.

### Example 7-2 and Reference Examples 7-1 and 7-2

Multilayer structures were produced in the same manner as in Example 7-1, except that PVA 7-2, PVA 7-3, and PVA 7-4 were used in place of PVA 7-1. The oxygen transmission rates of the multilayer structures obtained were evaluated following 35 the method described above. The results are summarized in Table 4.

TABLE 15

| | | Oxygen transmission rate |
|---|---|---|
| | PVA | (cc/m² · day · atm) |
| Ex. 7-1 | PVA 7-1 | 125 |
| Ex. 7-2 | PVA 7-2 | 71 |
| Ref. Ex. 7-1 | PVA 7-3 | 119 |
| Ref. Ex. 7-2 | PVA 7-4 | 75 |

The multilayer structures containing the PVAs of Examples 7-1 and 7-2 had oxygen gas barrier properties comparable to the oxygen gas barrier properties observed in their respective Reference Examples 7-1 and 7-2, confirming that the multilayer structures of Examples 7-1 and 7-2 exhibit the same levels of barrier properties as the multilayer structures of their respective Reference Examples 7-1 and 7-2. The multilayer structures of the present invention, and packaging materials including same exhibit excellent oxygen gas barrier properties, and can contribute to saving petroleum resources and alleviating global warming.

### Synthesis Example 8-2

A uniform mixture of 50 parts of the plant-derived vinyl acetate of Synthesis Example 1-1 and 50 parts of ordinary petroleum-derived vinyl acetate was used as raw material to synthesize polyvinyl acetate following an ordinary method. A methanol solution of this polyvinyl acetate was used for saponification reaction with an alkali catalyst, and the product was dried to obtain a PVA (PVA 8-1). The PVA, obtained by desirably changing the production conditions (saponification conditions) from those used in Synthesis Example 3-2, had an average degree of polymerization of 1,750, and a degree of saponification of 98.5 mol %.

### Synthesis Example 8-3

A PVA (PVA 8-2) was obtained using the same method used in Synthesis Example 8-2, except that a uniform mixture of 30 parts of the plant-derived vinyl acetate of Synthesis Example 1-1 and 70 parts of ordinary petroleum-derived vinyl acetate was used as raw material, and that ordinary petroleum-derived ethylene was copolymerized.

The PVA had an average degree of polymerization of 1, 720, and a degree of saponification of 97.5 mol %. The ethylene unit content was 4.2 mol %.

A PVA resin (PVA 8-3) was synthesized by the same method used in Synthesis Example 8-2, using a raw material that is 100% ordinary petroleum-derived vinyl acetate. The PVA had a degree of saponification of 98.7 mol %, and an average degree of polymerization of 1,780.

### Synthesis Example 8-5

A PVA resin (PVA 8-4) was synthesized by the same method used in Synthesis

Example 8-3, using a raw material that is 100% ordinary petroleum-derived vinyl acetate. The PVA had a degree of saponification of 98.1 mol %, and an average degree of polymerization of 1,680. The ethylene unit content was 4.1 mol %.

### Examples 8-1 and 8-2 and Reference Examples 8-1 and 8-2

The PVA 8-1 to PVA 8-4 were dissolved by heat in 95° C. hot water for 2 hours to prepare coating agents having a solids concentration of 6%. The coating agents were evaluated using the method below. The results are presented in Table 16.

### Preparation Test of Coated Paper Using Coating Agent

The coating agent as a coating solution was hand-coated on glassine paper having a basis weight of 64 gsm, using a wire bar, at 20° C. The coating agent was dried at 105° C. for 1 minute with a cylindrical rotary dryer. The coating agent was coated in an amount of 1.0 gsm (one side) in terms of an amount of solids. The coated paper was humidified at 20° C., 65% RH for 72 hours, and was measured for its physical properties.

### Waterproofing Strength Test of Coated Paper

About 0.1 g of 20° C. ion-exchange water was dropped on the surface of the coated paper (the surface coated with the coating agent) produced by the method described above. After rubbing the surface with fingers, the state of dissolution of the coating agent was observed. The results were evaluated on the basis of the following criteria.
Good: Excellent waterproofing strength; no sliminess
Moderate: Partial emulsification of coating agent
Poor: Dissolution of coating agent

### Evaluation for Release Paper Applications: Air Resistance Measurement

The air resistance of the coated paper was measured with an Oken-type smoothness and air permeability tester according to JIS P 8117:2009.

### Evaluation for Release Paper Applications: Toluene Barrier Test

Colored toluene (red) dissolving red food dye was applied to the coated surface of the coated paper over a 5×5 cm area , and the extent of bleeding to the back surface (uncoated surface) was evaluated (small red dots or complete staining of the toluene-applied surface) using the following criteria.
5: No dots on back surface
4: A few dots (1 or 2 dots) are present
3: Large number of dots is present (about 10 to 20% of the toluene-applied surface)
2: Staining in about 50% of the toluene-applied surface
1: Staining over the whole toluene-applied surface

### Evaluation for Greaseproof Paper Applications: KIT Test, Folding KIT Test

A KIT test was conducted for flat and folded portions of the coated surface according to TAPPI No. T 559 cm-02. The coated paper was evaluated by visual inspection. A commercially available greaseproof paper using fluororesin has a kit value of typically 5 or more in its rating, and the paper does not pose a problem in normal use when it has an oil resistance with a grade of 5 or more. Accordingly, the preferred grade for the oil resistance of the coated paper is 5 or higher. In applications that require higher oil resistance, the grade is preferably 7 or higher, more preferably 10 or higher.

In the KIT test of folded portions, the coated paper was folded in half with the coated surface facing outside. The folded portion was then pressed down 0.7 mm over 1.0 mm width under the pressure of 2.5 kgf/cm2s to create a clean crease line. After unfolding the coated paper, the oil resistance at the folded portion was measured according to TAPPI No. T 559 cm-02. The measurement was made by visual inspection.

TABLE 16

| | Vinyl alcohol polymer | | | | | | | Greaseproof paper | |
|---|---|---|---|---|---|---|---|---|---|
| | | Viscosity- | Degree | Degree of | Coated | Release paper | | KIT test | KIT test |
| | | average | of | modification | paper | Air | Toluene | without | with |
| | | degree of | saponification | with ethylene | Waterproofing | resistance | barrier | folding | folding |
| | PVA | polymerization | (mol %) | (mol %) | strength | (sec) | properties | (Grade) | (Grade) |
| Ex. 8-1 | PVA 8-1 | 1750 | 98.5 | 0 | Moderate | 8400 | 5 | 12 | 3 |
| Ex. 8-2 | PVA 8-2 | 1720 | 97.5 | 4.2 | Good | 38000 | 3 | 12 | 7 |
| Ref. Ex. 8-1 | PVA 8-3 | 1780 | 98.7 | 0 | Moderate | 8600 | 5 | 12 | 3 |
| Ref. Ex. 8-2 | PVA 8-4 | 1680 | 98.1 | 4.1 | Good | 35000 | 3 | 12 | 7 |

The coating agents containing the PVAs of Examples 8-1 and 8-2 were comparable to the coating agents of their respective Reference Examples 8-1 and 8-2 in terms of the properties of the coated paper, confirming that the coating agents of Examples 8-1 and 8-2 were as capable as the coating agents of their respective Reference Examples 8-1 and 8-2. The papercoating agents of the present invention, and paper coated therewith have excellent barrier properties and excellent oil resistance, and can contribute to saving petroleum resources and alleviating global warming.

1. A vinyl alcohol polymer (X) obtained through saponification after polymerization of a plant-derived vinyl ester monomer (A) and a petroleum-derived vinyl ester monomer (B), and having a mole ratio (A)/(B) of 5/95 to 100/0.

2. The vinyl alcohol polymer (X) according to claim 1, which comprises an ethylene unit, the content of the ethylene unit being 1 mol % or more and less than 20 mol %.

3. An additive for slurries, comprising a vinyl alcohol polymer (X) of claim 1.

4. A drilling mud comprising an additive for slurries of claim 3.

5. The drilling mud according to claim 4, which further comprises water and bentonite.

6. A cement slurry comprising an additive for slurries of claim 3.

7. The cement slurry according to claim 6, which further comprises a liquid and a hardening powder.

8. A sealing agent for underground treatment, comprising a vinyl alcohol polymer (X) of claim 1, and having a mole ratio (A)/(B) of 5/95 to 90/10.

9. The sealing agent for underground treatment according to claim 8, wherein the vinyl alcohol polymer (X) comprises an additional unsaturated monomer (C) that is copolymerizable with vinyl ester monomers.

10. The sealing agent for underground treatment according to claim 8, which further comprises a plasticizer.

11. A multilayer structure comprising a layer (C) containing a vinyl alcohol polymer (X) of claim 1, and a layer (D) containing a resin,
the resin being at least one selected from the group consisting of a polyolefin resin, a polyester resin, a polyamide resin, a polyvinyl chloride (PVC) resin, an ABS resin, a polylactic acid (PLA) resin, a polybutylene succinate (PBS) resin, a polyhydroxyalkanoate (PHA) resin, a polyhydroxybutyrate/hydroxyhexanoate (PHBH) resin, a starch, and a cellulose.

12. A method for producing a multilayer structure of claim 11, comprising the steps of:
obtaining a coating agent by preparing an aqueous solution containing the vinyl alcohol polymer (X); and
coating the coating agent on a surface of a substrate containing a resin,
the resin being at least one selected from the group consisting of a polyolefin resin, a polyester resin, a polyamide resin, a polyvinyl chloride (PVC) resin, an ABS resin, a polylactic acid (PLA) resin, a polybutylene succinate (PBS) resin, a polyhydroxyalkanoate (PHA) resin, a polyhydroxybutyrate/hydroxyhexanoate (PHBH) resin, a starch, and a cellulose.

13. A packaging material comprising a multilayer structure of claim 11.

14. A papercoating agent comprising a vinyl alcohol polymer (X) of claim 1.

15. A coated paper comprising a paper coated with a papercoating agent of claim 14.

16. The coated paper according to claim 15, which is a release paper base.

17. The coated paper according to claim 15, which is a greaseproof paper.

18. A seed coating composition comprising a vinyl alcohol polymer (X) of claim 1.

19. The seed coating composition according to claim 18, which further comprises one or more hydrophobic pesticides.

20. An aqueous emulsion comprising a dispersant and a dispersoid,
the dispersoid comprising a polymer (Y1) containing an ethylenically unsaturated monomer unit,
the dispersant comprising a vinyl alcohol polymer (X) of claim 1.

21. The aqueous emulsion according to claim 20, wherein:
the polymer (Y1) containing an ethylenically unsaturated monomer unit is a polymer having a specific unit derived from at least one selected from the group consisting of a vinyl ester monomer, a (meth)acrylic acid ester monomer, a styrene monomer, and a diene monomer, and
the content of the unit is 70 mass % or more with respect to all monomer units of the polymer.

22. The aqueous emulsion according to claim 20, which further comprises a polyisocyanate compound.

23. An adhesive agent comprising an aqueous emulsion of claim 20.

24. A dispersion stabilizer for suspension polymerization of vinyl compounds, comprising a vinyl alcohol polymer (X) of claim 1.

25. A method for producing a vinyl resin, comprising the step of polymerizing a vinyl compound by suspension polymerization in the presence of a dispersion stabilizer for suspension polymerization of claim 24.

26. The method for producing a vinyl resin according to claim 25, which comprises the step of polymerizing a vinyl compound by suspension polymerization in the presence of the dispersion stabilizer for suspension polymerization and an auxiliary dispersion stabilizer,
the auxiliary dispersion stabilizer comprising a vinyl alcohol polymer (Y2) having a degree of saponification of less than 65 mol %.

27. An auxiliary dispersion stabilizer for suspension polymerization of vinyl compounds, comprising a vinyl alcohol polymer (X) of claim 1,
the vinyl alcohol polymer (X) having a degree of saponification of 20 mol % or more and less than 60 mol %.

28. A method for producing a vinyl resin, comprising the step of polymerizing a vinyl compound by suspension polymerization in the presence of an auxiliary dispersion stabilizer for suspension polymerization of claim 27 and a dispersion stabilizer for suspension polymerization,
the dispersion stabilizer for suspension polymerization comprising a vinyl alcohol polymer (Y3) having a degree of saponification of 65 mol % or more, and a viscosity-average degree of polymerization of 600 or more.

29. The method for producing a vinyl resin according to claim 28, wherein the dispersion stabilizer and the auxiliary dispersion stabilizer have a mass ratio of 95/5 to 20/80 (dispersion stabilizer/auxiliary dispersion stabilizer).
